(19) United States
(12) Patent Application Publication
(10) Pub. No.: US 2026/0013504 A1
(43) Pub. Date: Jan. 15, 2026

(54) HERBICIDAL MIXTURE, HERBICIDAL COMPOSITION, METHOD, USE, AND KITS FOR CONTROLLING UNDESIRABLE VEGETATION

(71) Applicant: ADAMA AGAN LTD., Ashdod (IL)

(72) Inventors: Chuanwei YUAN, Beijing (CN); Hadas MIRYAMCHIK, Tel Aviv (IL)

(73) Assignee: ADAMA AGAN LTD., Ashdod (IL)

(21) Appl. No.: 18/866,206

(22) PCT Filed: May 15, 2023
(86) PCT No.: PCT/CN2023/094177

§ 371 Date: Nov. 15, 2024

(30) Foreign Application Priority Data
May 16, 2022 (WO) PCT/CN2022/093038

(51) Int. Cl. A01N 43/80; A01N 33/22; A01N 43/36; A01N 43/40; A01N 43/70; A01P 13/00

(52) U.S. Cl. CPC A01N 43/80; A01N 33/22; A01N 43/36; A01N 43/40; A01N 43/70; A01P 13/00

(57) ABSTRACT

The present disclosure relates to a herbicidal mixture comprising pyroxasulfone and a second herbicide selected from the group consisting of fluorochloridone, aclonifen, diflufenican and terbutryn. The present disclosure also relates to an herbicidal composition comprising pyroxasulfone, chlorotoluron, mesosulfuron-methyl and at least one agricultural carrier. The present disclosure also relates to a method, an use, and kits for controlling undesirable vegetation.

### TECHNICAL FIELD

The present disclosure relates to a herbicidal mixture comprising pyroxasulfone and a second herbicide selected from the group consisting of fluorochloridone, aclonifen, diflufenican and terbutryn. The present disclosure also relates to a herbicidal composition, which comprises the herbicidal mixture disclosed in the present disclosure, and an agriculturally acceptable carrier. The present disclosure discloses a method for controlling undesirable vegetation, which includes applying an herbicidally effective amount of the herbicidal mixture or the herbicidal composition disclosed herein to the undesirable vegetation or its locus. The present disclosure also discloses an use of the herbicidal mixture or the herbicidal composition disclosed herein for controlling undesired vegetation. The present disclosure also discloses a kit comprising the herbicidal mixture or the herbicidal composition disclosed herein.

### BACKGROUND

In order to obtain high crop efficiency, the control of undesirable vegetation is extremely important. In many cases, although herbicides have an effect on a certain weed spectrum, they do not exhibit efficacy against other types of weeds which are also present in the crops to be protected. Therefore, there is an urgent need to mix two, three or more herbicides. In addition, the application of two, three or more active ingredients of herbicide with different functioning manners may bring about many advantages, such as expanded weed spectrum, reduced application rate, reduced number of applications, and in some cases synergy effect (in which the efficacy increases).

Compared with applying a single herbicide, a mixture of selected herbicides may also have the following advantages, including: (a) enlarging the spectrum of the weeds to be controlled, or extending the control of weeds for a longer period of time; (b) improving crop safety by applying the lowest dosage of the selected multiple herbicides in a combination instead of a single high dosage of one herbicide, and (c) delaying sprouting of the weed species resistant to the selected multiple herbicides (Int. J. Agri. Biol., Vol. 6, No. 1, 2004, pp. 209-212).

However, the activity and selectivity of any specific mixture is difficult to predict, since the performance of each single herbicide in the mixture is often affected by the presence of the other herbicide(s). Moreover, the activity of the mixture may also vary significantly depending on chemical properties, plant species, growth stage, environmental conditions, application rate, and so on.

Pyroxasulfone, 3-[(5-difluoromethoxy-1-methyl-3-trifluoromethylpyrazol-4-yl)methylsulfonyl]-4,5-dihydro-5,5-di methyl-1,2-isoxazole, with a structural formula of

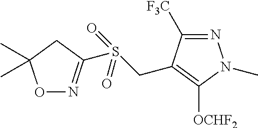

is disclosed in WO2002062770A1 by Kumiai Chemical Industry Co., Ltd, etc. The CAS registry number of pyroxasulfone is 447399-55-5, and it is an herbicide of elongation synthase inhibitor of very long chain fatty acid. As a soil treatment agent, it may be used in crops such as wheat, corn, peanut, soybean, and cotton to control multiple kinds of gramineous weeds and broad-leaved weeds, such as Setaria P. Beauv., Digitaria, Echinochloa Beauv., etc.

The chemical name of fluorochloridone is 3-chloro-4-(chloromethyl)-1-(3-(trifluoromethyl)phenyl)-2-pyrrolidione, with a structural formula of

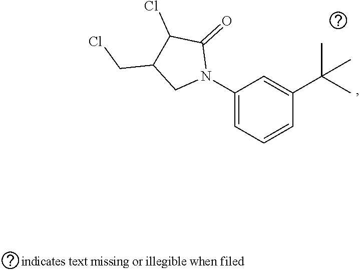 [SMILES: CC(C)(C)c1cccc(N2CC(CCl)C(Cl)C2=O)c1]

and its CAS registry number is 61213-25-0. Fluorochloridone is a carotenoid synthesis inhibitor, which may be used in winter wheat, cotton, sunflower and other crops to control a variety of broad-leaved weeds, such as Stellaria media (L.) Villars, Galium aparine and so on.

Aclonifen, i.e., 2-chloro-6-nitrio-3-phenoxyaniline, with a structural formula of

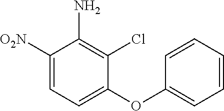 [SMILES: Nc1c([N+](=O)[O-])ccc(Oc2ccccc2)c1Cl]

is disclosed in USRE31717E1 by CELAMERCK. Aclonifen has a CAS registry number 74070-46-5, is a protoporphyrinogen oxidase inhibitor and may be used in sunflowers, winter wheat, and other crops to control a variety of gramineous weeds and broad-leaved weeds, such as tellaria media (L.) Villars, Galium aparine, and so on.

Diflufenican, i.e., N-(2,4-difluorophenyl)-2-(3-(trifluoromethyl) phenoxy)-3-pyridinecarboxamide, with a structural formula of

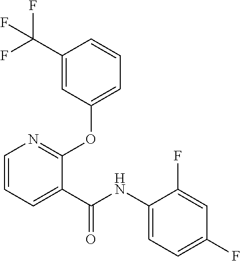 [SMILES: O=C(Nc1ccc(F)cc1F)c1cccnc1Oc1cccc(C(F)(F)F)c1]

is disclosed in U.S. Pat. No. 4,618,366 by RHONE-POULENC AGRICULTURE LTD. Diflufenican has a CAS registry number 83164-33-4, is a carotenoid synthesis inhibitor and may be used in wheat, barley, and other crops to control a variety of gramineous weeds and broad-leaved weeds, such as tellaria media (L.) Villars, Galium aparine, and so on.

The chemical name of terbutryn is N-(1,1-dimethylethyl)-N′-ethyl-6-(methylthio)-1,3,5-triazine-2,4-diamine, with a structural formula of

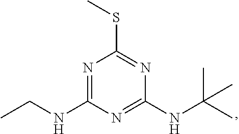 [SMILES: CCNc1nc(NC(C)(C)C)nc(SC)n1]

and its CAS registry number is 886-50-0. Terbutryn is a PSII inhibitor, which may be used in wheat, barley, and other crops to control a variety of weeds, such as Stellaria media (L.) Villars, Alopecurus aequalis Sobol, and so on.

There is a continuing need in the art for herbicidal mixtures, herbicidal compositions, methods, use, and kits for controlling growth of undesirable vegetation.

### SUMMARY

According to one aspect, the present disclosure provides a herbicidal mixture comprising pyroxasulfone and a second herbicide selected from the group consisting of fluorochloridone, aclonifen, diflufenican and terbutryn.

According to another aspect, the present disclosure relates to a herbicidal composition comprising the herbicidal mixture of the present disclosure and an agriculturally acceptable carrier.

According to another aspect, the present disclosure provides a method for controlling undesirable vegetation, which includes applying an herbicidally effective amount of the herbicidal mixture or the herbicidal composition of the present disclosure to the undesirable vegetation or its locus.

According to another aspect, the present disclosure provides an use of the herbicidal mixture or the herbicidal composition of the present disclosure for controlling undesired vegetation.

According to another aspect, the present disclosure provides a kit comprising the herbicidal mixture or the herbicidal composition of the present disclosure.

More particularly, the present disclosure provides the following technical solutions:
1. A herbicidal mixture comprising pyroxasulfone and a second herbicide selected from the group consisting of fluorochloridone, aclonifen, diflufenican and terbutryn.
2. The herbicidal mixture of embodiment 1, wherein the second herbicide is fluorochloridone, and the weight ratio of pyroxasulfone to fluorochloridone is (0.08˜1.6): 1.
3. The herbicidal mixture of embodiment 2, wherein the weight ratio of pyroxasulfone to fluorochloridone is (0.15˜0.8): 1.
4. The herbicidal mixture of any one of embodiments 2 to 3, wherein the weight ratio of pyroxasulfone to fluorochloridone is (0.3˜0.4): 1.
5. The herbicidal mixture of any one of embodiments 2 to 4, wherein the weight ratio of pyroxasulfone to fluorochloridone is 0.36:1.
6. The herbicidal mixture of embodiment 1, wherein the second herbicide is aclonifen, and the weight ratio of pyroxasulfone to aclonifen is (0.02˜0.32): 1.
7. The herbicidal mixture of embodiment 6, wherein the weight ratio of pyroxasulfone to aclonifen is (0.03˜0.16): 1.
8. The herbicidal mixture of any one of embodiments 6 to 7, wherein the weight ratio of pyroxasulfone to aclonifen is (0.07˜0.08): 1.
9. The herbicidal mixture of any one of embodiments 6 to 8, wherein the weight ratio of pyroxasulfone to aclonifen is 0.075:1.
10. The herbicidal mixture of embodiment 1, wherein the second herbicide is diflufenican, and the weight ratio of pyroxasulfone to diflufenican is (0.1˜3.6): 1.
11. The herbicidal mixture of embodiment 10, wherein the weight ratio of pyroxasulfone to diflufenican is (0.3˜1.8): 1.
12. The herbicidal mixture of any one of embodiments 10 to 11, wherein the weight ratio of pyroxasulfone to diflufenican is (0.7˜0.9): 1.
13. The herbicidal mixture of any one of embodiments 10 to 12, wherein the weight ratio of pyroxasulfone to diflufenican is 0.8:1.
14. The herbicidal mixture of embodiment 1, wherein the second herbicide is terbutryn, and the weight ratio of pyroxasulfone to terbutryn is (0.01˜0.36): 1.
15. The herbicidal mixture of embodiment 14, wherein the weight ratio of pyroxasulfone to terbutryn is (0.03˜0.18): 1.
16. The herbicidal mixture of any one of embodiments 14 to 15, wherein the weight ratio of pyroxasulfone to terbutryn is (0.07˜0.09): 1.
17. The herbicidal mixture of any one of embodiments 14 to 16, wherein the weight ratio of pyroxasulfone to terbutryn is 0.08:1.
18. The herbicidal mixture of any one of embodiments 1 to 17 wherein pyroxasulfone and the second herbicide are applied jointly or in a succession.
19. The herbicidal mixture of any one of embodiments 1 to 5 and 18, wherein the second herbicide is fluorochloridone, the application rate of pyroxasulfone is 11.25 to 360 g ai/ha, and the application rate of fluorochloridone is 31.25 to 1000 g ai/ha.
20. The herbicidal mixture of any one of embodiments 1, 6 to 9 and 18, wherein the second herbicide is aclonifen, the application rate of pyroxasulfone is 11.25 to 360 g ai/ha, and the application rate of aclonifen is 150 to 4800 g ai/ha.
21. The herbicidal mixture of any one of embodiments 1, 10 to 13 and 18, wherein the second herbicide is diflufenican, the application rate of pyroxasulfone is 11.25 to 360 g ai/ha, and the application rate of diflufenican is 14.0625 to 450 g ai/ha.
22. The herbicidal mixture of any one of embodiments 1, 14 to 18, wherein the second herbicide is terbutryn, the application rate of pyroxasulfone is 11.25 to 360 g ai/ha, and the application rate of terbutryn is 140.625 to 4500 g ai/ha.
23. The herbicidal mixture of any one of embodiments 1 to 22, wherein the herbicidal mixture is synergistic.
24. The herbicidal mixture of any one of embodiments 1 to 23, wherein the herbicidal mixture is consisted of pyroxasulfone and the second herbicide.
25. A herbicidal composition comprising the herbicidal mixture of any one of embodiments 1 to 24, and an agriculturally acceptable carrier.
26. The herbicidal composition of embodiment 25, further comprising at least one surfactant.
27. A method of controlling undesired vegetation comprising applying to the undesirable vegetation or its locus a herbicidally effective amount of the herbicidal mixture of any one of embodiments 1 to 24 or the herbicidal composition of any one of embodiments 25-26.
28. The method of embodiment 27 wherein the undesired vegetation is controlled in wheat.
29. The method of embodiment 27 or 28 wherein the undesired vegetation is selected from the group consisting of Aegilops tauschii, Bromus japonicus, Lolium multiflorum Lamk, Galium aparine, Lithospermum arvense, Solanum nigrum, and the combination thereof.
30. An use of the herbicidal mixture of any one of embodiments 1 to 24 or the herbicidal composition of any one of embodiments 25-26 for controlling undesired vegetation.
31. A kit comprising the herbicidal mixture of any one of embodiments 1 to 24 or the herbicidal composition of any one of embodiments 25-26.

### DETAILED DESCRIPTION

Before elaborating the present disclosure in detail, it may be helpful to provide definitions of some terms used herein. Unless otherwise specified, all technical and scientific terms used herein have the same meaning as commonly understood by those of ordinary skill in the art to which the present disclosure belongs.

As used herein, the phrase “an agriculturally acceptable carrier” refers to a carrier known in the art and accepted for forming a variety of formulations for agricultural or horticultural application.

As used herein, the term “plant” or “crop” includes whole plants, plant organs (e.g., leaves, stems, branches, roots, trunks, wickers, twigs, fruits, etc.), plant cells or plant seeds. This term also includes plant crops such as fruits. In another embodiment, the term “plant” or “vegetation” may include the propagation materials of the plant, and the propagation materials may include all reproductive parts of the plant, e.g., seeds and vegetative plant materials, such as cuttings and various tubers that may be used for plant propagation. The plants include seed, tuber, spore, carmus, bulb, rhizome, sprout, stolon, bud and other parts of plants including seedling and young plant which are transplanted after germinating or sprouting from the soil.

As used herein, the term “locus” includes not only places where undesirable vegetation (e.g., weeds) may have grown, but also places where undesirable vegetation (e.g., weeds) has not yet appeared, and the cultivation areas.

As used herein, the term “post-emergence” refers to the application of a herbicidal mixture or a herbicidal composition to undesirable vegetation (e.g., weeds) sprouting from the soil, and the term “pre-emergence” refers to the application of a herbicidal mixture or a herbicidal composition to the locus, weeds, or soil before the undesirable vegetation (e.g., weeds) sprouting from the soil.

As used herein, the term “controlling undesirable vegetation” refers to disturbing the normal growth and development of undesirable vegetation. Various examples of controlling activities include, but are not limited to: inhibiting root growth, inhibiting sprout growth, inhibiting sprouting, inhibiting seed production, or reducing the biomass of weeds.

As used herein, the term “effective amount” means that the amount of the active ingredient is sufficient to achieve a good level of control when it is ingested, contacted, or perceived. As used herein, the term “herbicidally effective amount” refers to the amount of the active ingredient that produces herbicidal effect. As used herein, the term “herbicidally effective application rate” refers to the application rate of the active ingredient that produces herbicidal effect.

As used herein, the term “synergistic” means the combined effect of the active ingredients is greater than the sum of the effects of each individual ingredient. The term “synergistically effective amount” is an amount exhibiting an herbicidal activity greater than the sum of the herbicidal activities of the individual components.

As used herein, the term “mixture” or “composition” refers to but not limited to any combination of physical forms, e.g., blends, solutions, or alloys.

As used herein, the term “ha” refers to hectares.

As used herein, the term “ai” refers to active ingredient.

The term “surfactant” as used herein refers to an agriculturally acceptable material providing emulsification, stability, spreading, wetting, dispersibility, or other surface modification properties.

Unless otherwise indicated, the singular forms “a” and “an” as used herein include both the singular and the plural forms. Therefore, the terms “a”, “an” or “at least one” may be used interchangeably in the present disclosure.

Throughout the application, the description of various embodiments uses the term “include (or comprise)”; however, those skilled in the art will understand that in some specific cases, the language “substantially consists of” or “consists of” may be used interchangeably to describe embodiments. The term “consisting of” means that the mixture or composition before the term comprises only the components listed after the term and no longer comprises other components, but may comprise impurities, and the impurities are only allowed to exist in a usual amount.

In order to better understand the teachings of the present disclosure, and in no way limiting the scope of the teachings, unless otherwise specified, all the numerical values, percentages or ratios, reaction conditions, and other numerical values used in the specification and schemes will be understood as being modified by the term “about” in all cases. Therefore, unless there is an indication to the contrary, the numerical parameters proposed in the following description and solutions are approximate values, and may be changed depending on the desired properties to be obtained. At the very least, each numerical parameter should be interpreted at least based on the value of the reported significant figures and by applying the usual rounding technique. In this regard, the use of the term “about” as used herein specifically comprises a range value of +10% of the specified value. In addition, all ranges related to the same composition or characteristic of the present disclosure formed by end points (including the end points, and also including all intermediate points and ranges), may be independently combined.

### First Aspect

In the first aspect, the present disclosure provides a herbicidal mixture comprising pyroxasulfone and a second herbicide selected from the group consisting of fluorochloridone, aclonifen, diflufenican and terbutryn. It is found that, compared to the weed control expected to be observed on the basis of two individual herbicides, the herbicidal mixture may provide a broader spectrum of weed control, a reduced dosage of individual herbicide, or a synergistically herbicidal effect.

In one embodiment of the present disclosure, in the herbicidal mixture, pyroxasulfone and the second herbicide are present in synergistically herbicidally effective amounts.

In one embodiment of the present disclosure, in the herbicidal mixture, the second herbicide is fluorochloridone, and the weight ratio of pyroxasulfone to fluorochloridone is (0.08˜1.6): 1. When the weight ratio of pyroxasulfone to fluorochloridone is (0.08˜1.6): 1, in the relative amount range of (0.08˜1.6) for pyroxasulfone, the relative amount of pyroxasulfone may be 0.08, 0.09, 0.1, 0.15, 0.2, 0.25, 0.3, 0.36, 0.4, 0.45, 0.5, 0.55, 0.6, 0.65, 0.7, 0.75, 0.8, 0.85, 0.9, 0.95, 1, 1.1, 1.15, 1.2, 1.25, 1.3, 1.35, 1.4, 1.45, 1.5, 1.55, 1.6; and any relative amount range formed by any two of the above mentioned relative amounts as two ends, such as (0.09˜1.5), (0.2˜0.7), (0.85˜1.25), (0.15˜0.8), or (0.3˜0.4), etc. For example, the weight ratio of pyroxasulfone to fluorochloridone may be (0.09˜1.5): 1, (0.2˜0.7): 1, (0.85˜1.25): 1, (0.15˜0.8): 1, (0.3˜0.4): 1, or 0.36:1.

In one embodiment of the present disclosure, in the herbicidal mixture, the second herbicide is aclonifen, and the weight ratio of pyroxasulfone and aclonifen is (0.02˜0.32): 1. When the weight ratio of pyroxasulfone and aclonifen is (0.02˜0.32): 1, in the relative amount range of (0.02˜0.32) for pyroxasulfone, the relative amount of pyroxasulfone may be 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32; and any relative amount range formed by any two of the above mentioned relative amounts as two ends, such as (0.03˜0.31), (0.1˜0.3), (0.03˜0.16), (0.07˜0.08), or (0.06˜0.15), etc. For example, the weight ratio of pyroxasulfone and aclonifen may be (0.03˜0.31): 1, (0.1˜0.3): 1, (0.03˜0.16): 1, (0.07˜0.08): 1, or (0.06˜0.15): 1, or 0.075:1.

In one embodiment of the present disclosure, in the herbicidal mixture, the second herbicide is diflufenican, and the weight ratio of pyroxasulfone and diflufenican is (0.1˜3.6): 1. When the weight ratio of pyroxasulfone and diflufenican is (0.1˜3.6): 1, in the relative amount range of (0.1˜3.6) for pyroxasulfone, the relative amount of pyroxasulfone may be 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3, 3.1, 3.2, 3.3, 3.4, 3.5, 3.6; and any relative amount range formed by any two of the above mentioned relative amounts as two ends, such as (0.3˜3.5), (1˜3), (0.3˜1.8), ((0.7˜0.9), or (0.6˜1.5), etc. For example, the weight ratio of pyroxasulfone and diflufenican may be (0.3˜3.5): 1, (1˜3): 1, (0.3˜1.8): 1, (0.7˜0.9): 1, or (0.6˜1.5): 1, or 0.8:1.

In one embodiment of the present disclosure, in the herbicidal mixture, the second herbicide is terbutryn, and the weight ratio of pyroxasulfone and terbutryn is (0.01˜0.36): 1. When the weight ratio of pyroxasulfone and terbutryn is (0.01˜0.36): 1, in the relative amount range of (0.01˜0.36) for pyroxasulfone, the relative amount of pyroxasulfone may be 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36; and any relative amount range formed by any two of the above mentioned relative amounts as two ends, such as (0.03˜0.35), (0.1˜0.3), (0.03˜0.18), ((0.07˜0.09), or (0.06˜0.15), etc. For example, the weight ratio of pyroxasulfone and terbutryn may be (0.03˜0.35): 1, (0.1˜0.3): 1, (0.03˜0.18): 1, (0.07˜0.09): 1, or (0.06˜0.15): 1, or 0.08:1.

In one embodiment of the present disclosure, pyroxasulfone and the second herbicide selected from the group consisting of fluorochloridone, aclonifen, diflufenican and terbutryn are applied in combination or sequentially. In one example, pyroxasulfone and the second herbicide selected from the group consisting of fluorochloridone, aclonifen, diflufenican and terbutryn are separately prepared, and each of them is applied as it is, or diluted to a predetermined concentration for application. In another example, pyroxasulfone and the second herbicide selected from the group consisting of fluorochloridone, aclonifen, diflufenican and terbutryn are separately prepared, and after being diluted to a predetermined concentration if necessary, they are mixed and then applied. In another example, pyroxasulfone and the second herbicide selected from the group consisting of fluorochloridone, aclonifen, diflufenican and terbutryn are formulated together, and then applied as it is, or diluted to a predetermined concentration for application.

The herbicidally effective application rate of each active ingredient of the herbicidal mixture generally varies with various conditions, e.g., the type of formulation, weather conditions, type of crops, and type of weeds.

In one embodiment of the present disclosure, the application rate of pyroxasulfone is 11.25 to 360 g ai/ha. In the range of 11.25 to 360 g ai/ha, the application rate of pyroxasulfone may be 11.25 g ai/ha, 15 g ai/ha, 20 g ai/ha, 22.5 g ai/ha, 30 g ai/ha, 45 g ai/ha, 60 g ai/ha, 75 g ai/ha, 90 g ai/ha, 100 g ai/ha, 110 g ai/ha, 120 g ai/ha, 130 g ai/ha, 140 g ai/ha, 150 g ai/ha, 160 g ai/ha, 170 g ai/ha, 180 g ai/ha, 190 g ai/ha, 200 g ai/ha, 210 g ai/ha, 220 g ai/ha, 230 g ai/ha, 240 g ai/ha, 250 g ai/ha, 260 g ai/ha, 270 g ai/ha, 280 g ai/ha, 290 g ai/ha, 300 g ai/ha, 310 g ai/ha, 320 g ai/ha, 330 g ai/ha, 340 g ai/ha, 350 g ai/ha, 360 g ai/ha; and any application rate range formed by any two of the above mentioned application rates as two ends. For example, the application rate of pyroxasulfone may be 22.5 to 180 g ai/ha, 11.25 to 22.5 g ai/ha, 11.25 to 45 g ai/ha, 11.25 to 90 g ai/ha, or 11.25 to 180 g ai/ha.

In one embodiment of the present disclosure, the application rate of fluorochloridone is 31.25 to 1000 g ai/ha. In the range of 31.25 to 1000 g ai/ha, the application rate of fluorochloridone may be 31.25 g ai/ha, 45 g ai/ha, 60 g ai/ha, 62.5 g ai/ha, 75 g ai/ha, 90 g ai/ha, 100 g ai/ha, 110 g ai/ha, 120 g ai/ha, 125 g ai/ha, 150 g ai/ha, 175 g ai/ha, 200 g ai/ha, 250 g ai/ha, 300 g ai/ha, 350 g ai/ha, 400 g ai/ha, 450 g ai/ha, 500 g ai/ha, 550 g ai/ha, 600 g ai/ha, 650 g ai/ha, 700 g ai/ha, 750 g ai/ha, 800 g ai/ha, 850 g ai/ha, 900 g ai/ha, 950 g ai/ha, 1000 g ai/ha; and any application rate range formed by any two of the above mentioned application rates as two ends. For example, the application rate of fluorochloridone may be 62.5 to 500 g ai/ha, 31.25 to 62.5 g ai/ha, 31.25 to 500 g ai/ha, 31.25 to 125 g ai/ha.

In one embodiment of the present disclosure, the application rate of aclonifen is 150 to 4800 g ai/ha. In the range of 150 to 4800 g ai/ha, the application rate of aclonifen may be 150 g ai/ha, 200 g ai/ha, 250 g ai/ha, 300 g ai/ha, 400 g ai/ha, 500 g ai/ha, 600 g ai/ha, 700 g ai/ha, 800 g ai/ha, 900 g ai/ha, 1000 g ai/ha, 1100 g ai/ha, 1200 g ai/ha, 1300 g ai/ha, 1400 g ai/ha, 1500 g ai/ha, 1600 g ai/ha, 1700 g ai/ha, 1800 g ai/ha, 1900 g ai/ha, 2000 g ai/ha, 2100 g ai/ha, 2200 g ai/ha, 2300 g ai/ha, 2400 g ai/ha, 2500 g ai/ha, 2600 g ai/ha, 2700 g ai/ha, 2800 g ai/ha, 2900 g ai/ha, 3000 g ai/ha, 3100 g ai/ha, 3200 g ai/ha, 3300 g ai/ha, 3400 g ai/ha, 3500 g ai/ha, 3600 g ai/ha, 3700 g ai/ha, 3800 g ai/ha, 3900 g ai/ha, 4000 g ai/ha, 4100 g ai/ha, 4200 g ai/ha, 4300 g ai/ha, 4400 g ai/ha, 4500 g ai/ha, 4600 g ai/ha, 4700 g ai/ha, 4800 g ai/ha; and any application rate range formed by any two of the above mentioned application rates as two ends. For example, the application rate of aclonifen may be 150 to 2400 g ai/ha, 150 to 300 g ai/ha, 150 to 600 g ai/ha,

In one embodiment of the present disclosure, the application rate of diflufenican is 14.0625 to 450 g ai/ha. In the range of 14.0625 to 450 g ai/ha, the application rate of diflufenican may be 14.0625 g ai/ha, 15 g ai/ha, 20 g ai/ha, 28.125 g ai/ha, 30 g ai/ha, 45 g ai/ha, 56.25 g ai/ha, 60 g ai/ha, 75 g ai/ha, 90 g ai/ha, 100 g ai/ha, 110 g ai/ha, 112.5 g ai/ha, 120 g ai/ha, 130 g ai/ha, 140 g ai/ha, 150 g ai/ha, 160 g ai/ha, 170 g ai/ha, 180 g ai/ha, 190 g ai/ha, 200 g ai/ha, 210 g ai/ha, 220 g ai/ha, 225g ai/ha, 230 g ai/ha, 240 g ai/ha, 250 g ai/ha, 260 g ai/ha, 270 g ai/ha, 280 g ai/ha, 290 g ai/ha, 300 g ai/ha, 310 g ai/ha, 320 g ai/ha, 330 g ai/ha, 340 g ai/ha, 350 g ai/ha, 360 g ai/ha, 370 g ai/ha, 380 g ai/ha, 390 g ai/ha, 400 g ai/ha, 410 g ai/ha, 420 g ai/ha, 430 g ai/ha, 440 g ai/ha, 450 g ai/ha, and any application rate range formed by any two of the above mentioned application rates as two ends. For example, the application rate of diflufenican may be 14.0625 to 28.125 g ai/ha, 14.0625 to 56.25 g ai/ha, 14.0625 to 112.5 g ai/ha, or 14.0625 to 225 g ai/ha.

In one embodiment of the present disclosure, the application rate of terbutryn is 140.625 to 4500 g ai/ha. In the range of 140.625 to 4500 g ai/ha, the application rate of terbutryn may be 140.625 g ai/ha, 150 g ai/ha, 200 g ai/ha, 281.25 g ai/ha, 300 g ai/ha, 450 g ai/ha, 562.5 g ai/ha, 600 g ai/ha, 750 g ai/ha, 900 g ai/ha, 1000 g ai/ha, 1100 g ai/ha, 1125 g ai/ha, 1200 g ai/ha, 1300 g ai/ha, 1400 g ai/ha, 1500 g ai/ha, 1600 g ai/ha, 1700 g ai/ha, 1800 g ai/ha, 1900 g ai/ha, 2000 g ai/ha, 2100 g ai/ha, 2200 g ai/ha, 2250g ai/ha, 2300 g ai/ha, 2400 g ai/ha, 2500 g ai/ha, 2600 g ai/ha, 2700 g ai/ha, 2800 g ai/ha, 2900 g ai/ha, 3000 g ai/ha, 3100 g ai/ha, 3200 g ai/ha, 3300 g ai/ha, 3400 g ai/ha, 3500 g ai/ha, 3600 g ai/ha, 3700 g ai/ha, 3800 g ai/ha, 3900 g ai/ha, 4000 g ai/ha, 4100 g ai/ha, 4200 g ai/ha, 4300 g ai/ha, 4400 g ai/ha, 4500 g ai/ha, and any application rate range formed by any two of the above mentioned application rates as two ends. For example, the application rate of terbutryn may be 140.625 to 2250 g ai/ha, 140.625 to 281.25 g ai/ha, 140.625 to 1125 g ai/ha, or 140.625 to 562.5 g ai/ha.

In the above embodiments of the present disclosure, in the herbicidal mixture, while satisfying the limitation conditions for the herbicidally effective application rate of each active ingredient of the herbicidal mixture, the application rate of pyroxasulfone may be lower than that of the second herbicide, i.e., the ratio of the application rate of pyroxasulfone to that of the second herbicide is less than 1:1, particularly less than 0.9:1, less than 0.5:1, less than 0.4:1, less than 0.1:1, less than 0.09:1, more particularly less than 0.08:1.

In some embodiments of the present disclosure, in the herbicidal mixture, the ratio of the application rate of pyroxasulfone to that of fluorochloridone is in a range of 0.01125 to 12, for example 0.045 to 6, 0.09 to 3, or 0.18 to 1.5.

In some embodiments of the present disclosure, in the herbicidal mixture, the ratio of the application rate of pyroxasulfone to that of aclonifen is in a range of 0.002 to 2.4, for example 0.004 to 1.2, 0.02 to 0.6, 0.04 to 0.3, 0.04 to 0.15, or 0.07 to 0.15.

In some embodiments of the present disclosure, in the herbicidal mixture, the ratio of the application rate of pyroxasulfone to that of diflufenican is in a range of 0.025 to 26, for example 0.05 to 13, 0.1 to 6.5, 0.2 to 3, or 0.4 to 1.5.

In some embodiments of the present disclosure, in the herbicidal mixture, the ratio of the application rate of pyroxasulfone to that of terbutryn is in a range of 0.002 to 2.6, for example 0.004 to 1.3, 0.02 to 0.6, 0.04 to 0.3, 0.04 to 0.15, or 0.07 to 0.15.

In some embodiments of the present disclosure, the herbicidal mixture is synergistic, i.e., the herbicidal active ingredients are more effective when they are applied in combination than when they are applied separately. Synergy may be defined as “the interaction of two or more factors makes the effect of the combination greater than the expected effect based on the response to the individual factor applied separately” (Shaner, D. L., Ed. Herbicide Handbook, 10th ed. Lawrence: Weed Society of America, 2014). In some embodiments, the herbicidal mixture exhibits a synergistic effect as determined by Colby equation (Colby, S. R. Calculation of the synergistic and antagonistic response of herbicide combinations. Weeds 1967, 15, 20-22). The calculation of the synergistic effect through the Colby equation is described in detail in the Example section of the present disclosure.

In one embodiment of the present disclosure, the herbicidal mixture may comprise other active ingredients, such as other herbicides, insecticides, fungicides, bactericides, nematicides, molluscicides, growth regulators, biological agents, fertilizers, safeners, or mixtures thereof. However, for the avoidance of doubt, it should be understood that such other active ingredients are not necessary for the herbicidal mixture of the present invention to achieve the desired control of undesirable vegetation. In a further embodiment of the present disclosure, the premise of the presence of other active ingredients is not affecting the synergistic effect of the herbicidal mixture.

In one embodiment of the present disclosure, the herbicidal mixture does not comprise ingredients other than active ingredients, such as agricultural carriers.

In one embodiment of the present disclosure, the herbicidal mixture substantially consists of pyroxasulfone and the second herbicide selected from the group consisting of fluorochloridone, aclonifen, diflufenican and terbutryn.

In one embodiment of the present disclosure, the herbicidal mixture consists of pyroxasulfone and the second herbicide selected from the group consisting of fluorochloridone, aclonifen, diflufenican and terbutryn. In one embodiment of the present disclosure, the herbicidal mixture consists of pyroxasulfone and fluorochloridone, pyroxasulfone and aclonifen, pyroxasulfone and diflufenican, or pyroxasulfone and terbutryn.

The herbicidal mixture may be applied pre-emergence, post-emergence, or a combination thereof.

### Second Aspect

In the second aspect, the present disclosure provides a herbicidal composition comprising the herbicidal mixture disclosed in the first aspect, and an agriculturally acceptable carrier. It is found that, compared to the weed control expected to be observed on the basis of multiple individual herbicides, the herbicidal composition may provide a greater spectrum of weed control, or a reduced dosage of individual herbicide, or a synergistically herbicidal effect.

In one embodiment of the present disclosure, in the herbicidal composition, pyroxasulfone and the second herbicide selected from the group consisting of fluorochloridone, aclonifen, diflufenican and terbutryn are present in synergistically herbicidally effective amounts.

In one embodiment of the present disclosure, the herbicidal composition further comprises at least one surfactant.

In one embodiment of the present disclosure, pyroxasulfone and the second herbicide selected from the group consisting of fluorochloridone, aclonifen, diflufenican and terbutryn are applied in combination or sequentially. In one example, pyroxasulfone and the second herbicide selected from the group consisting of fluorochloridone, aclonifen, diflufenican and terbutryn are separately prepared, and each of them is applied as it is, or diluted to a predetermined concentration for application. In another example, pyroxasulfone and the second herbicide selected from the group consisting of fluorochloridone, aclonifen, diflufenican and terbutryn are separately prepared, and after being diluted to a predetermined concentration if necessary, they are mixed and then applied. In another example, pyroxasulfone and the second herbicide selected from the group consisting of fluorochloridone, aclonifen, diflufenican and terbutryn are formulated together, and then applied as it is, or diluted to a predetermined concentration for application.

In some embodiments of the present disclosure, the herbicidal composition is synergistic, i.e., the herbicidal active ingredients are more effective when they are applied in combination than when they are applied separately. Synergy may be defined as “the interaction of two or more factors makes the effect of the combination greater than the expected effect based on the response to the individual factor applied separately” (Shaner, D. L., Ed. Herbicide Handbook, 10th ed. Lawrence: Weed Society of America, 2014). In some embodiments, the herbicidal composition exhibits a synergistic effect as determined by Colby equation (Colby, S. R. Calculation of the synergistic and antagonistic response of herbicide combinations. Weeds 1967, 15, 20-22). The calculation of the synergistic effect through the Colby equation is described in detail in the Example section of the present disclosure.

In one embodiment of the present disclosure, the herbicidal composition may comprise other active ingredients, such as other herbicides, insecticides, fungicides, bactericides, nematicides, molluscicides, growth regulators, biological agents, fertilizers, safeners or mixtures thereof. However, for the avoidance of doubt, it should be understood that such other active ingredients are not necessary for the herbicidal composition of the present invention to achieve the desired control of undesirable vegetation. In a further embodiment of the present disclosure, the premise of the presence of other active ingredients is not affecting the synergistic effect of the herbicidal composition.

In one embodiment of the present disclosure, the active ingredients of the herbicidal composition substantially consist of pyroxasulfone and the second herbicide selected from the group consisting of fluorochloridone, aclonifen, diflufenican and terbutryn.

In one embodiment of the present disclosure, the active ingredients of the herbicidal composition consist of pyroxasulfone and the second herbicide selected from the group consisting of fluorochloridone, aclonifen, diflufenican and terbutryn. In one embodiment of the present disclosure, the active ingredients of the herbicidal composition consist of pyroxasulfone and fluorochloridone, pyroxasulfone and aclonifen, pyroxasulfone and diflufenican, or pyroxasulfone and terbutryn.

The agricultural carrier comprised in the herbicidal composition of the present disclosure may be a solid carrier, or a liquid carrier. Examples of suitable solid carriers include: mineral soils such as silica gel, silicate, talc, kaolin, activated clay (attaclay), limestone, lime, chalk, red basalt, loess, clay, dolomite, diatomite, calcium sulfate, magnesium sulfate, magnesium oxide, a mixture of ground materials of sodium carbonate and sodium bicarbonate, and sodium sulfate, ground synthetic materials; fertilizers such as ammonium sulfate, ammonium phosphate, ammonium nitrate, urea; and plant-derived products such as grain flour, bark powder, wood powder and nut shell powder, cellulose powder, and other solid carriers. Examples of suitable liquid carriers include: water, alcohols such as methanol, cyclohexanol and decanol, ethylene glycol and propylene glycol, N,N-dimethylformamide, dimethyl sulfoxide, N-alkylpyrrolidone, aromatic hydrocarbons such as alkylbenzene and alkylnaphthalene, paraffin, olive oil, castor oil, linseed oil, tung oil, sesame oil, corn oil, peanut oil, cottonseed oil, soybean oil, rapeseed oil and coconut oil, aliphatic esters, ketones such as cyclohexanone, 2-heptanone, isophorone, 4-hydroxy-4-methyl-2-pentanone, etc.

In one embodiment of the present disclosure, the herbicidal composition of the present disclosure further comprises at least one surfactant. Examples of suitable surfactants comprised in the herbicidal composition of the present disclosure include, but are not limited to: nonionic, anionic, cationic and amphoteric types, such as alkoxylated fatty alcohol, ethoxylated polysorbate (e.g. Tween 20), ethoxylated castor oil, lignin sulfonate, fatty acid sulfonate (e.g. dodecyl sulfonate), phosphate ester such as phosphate ester of alcohol alkoxylate, phosphate ester of alkylphenol alkoxylate and phosphate ester of styrylphenol ethoxylate, sulfonated naphthalene and condensate of naphthalene derivative and formaldehyde, condensate of naphthalene or naphthalenesulfonic acid with phenol and formaldehyde, alkylarylsulphonate, ethoxylated alkylphenol and arylphenol, polyalkylene glycol, sorbitol ester, alkali metal (for example, sodium) lignosulfonate, tristyrylphenol ethoxylated phosphate ester, aliphatic alcohol ethoxylate, alkylphenol ethoxylate, ethylene oxide/propylene oxide block copolymer, graft copolymer, and polyvinyl alcohol-vinyl acetate copolymer. Other surfactants known in the art may be used as needed.

The herbicidal composition of the present disclosure may also comprise other ingredients, such as wetting agent, defoamer, adhesive, neutralizer, thickener, binder, chelating agent, stabilizer, buffer, or antifreezing agent, so as to increase the stability, density, viscosity, and so on of the composition.

Without departing from the scope of the present disclosure, the herbicidal composition of the present disclosure may also be applied together with one or more other herbicides to control a wider variety of undesirable vegetation. When being used in combination with other herbicides, the composition may be formulated with the other herbicides, tank mixed with the other herbicides, or applied sequentially with the other herbicides. Some of the other herbicides that may be used with the herbicidal composition of the present disclosure include, but are not limited to: chlorophenoxyacetic acid (4-CPA), chlorophenoxybutyric acid (4-CPB), chlorophenoxypropyl acid (4-CPP), 2,4-D, 2,4-D choline salt, 2,4-D ester and 2,4-D amine, 2,4-DB, 3,4-DA, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allylalcohol, pentachloropentanonic acid (alorac), ametridione, ametryn, amibuzin, amicarbazone, amidosulfuron, aminocyclopyrachlor, aminopyralid, amiprofos-methyl, amitrole, ammoniumsulfamate, anilofos, anisuron, asulam, atraton, atrazine, azafenidin, azimsulfuron, aziprotryne, barban, isopropyl m-chlorophenylcarbamate (BCPC), beflubutamid, benazolin, bencarbazone, benfuresate, bensulfuron-methyl, bensulide, benthiocarb, bentazon-sodium, benzadox, benzfendizone, benzipram, benzobicyclon, benzfendizone, benzofenap, benzofluor, benzoylprop, benzthiazuron, bialaphos, bicyclopyrone, bifenox, bilanafos, bispyribac-sodium, borax, bromacil, bromobonil, bromobutide, bromofenoxim, bromoxynil, brompyrazon, butachlor, butafenacil, butenachlor, buthidazole, buthiuron, butroxydim, buturon, butyrate, cacodylic acid, cafenstrole, calcium chlorate, calcium cyanamide, cambendichlor, carbasulam, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorsulfuron, chlorthal, chlorthiamid, cinidon-ethyl, cinmethylin, cinosulfuron, cisanilide, clethodim, cliodinate, clodinafop-propargyl, clofop, clomazone, clomeprop, cloprop, cloproxydim, clopyralid, cloransulam-methyl, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, 2-(2,4-dichlorophenoxy) propionic acid (dichlorprop), dichlorprop-P, diclofop-methyl, diclosulam, diethamquat, diethatyl, difenopenten, difenoxuron, difenzoquat, diflufenzopyr, dimefuron, dimepiperate, dimethachlor, dimethametryn, dimexano, dimidazon, dinofenate, dinoprop, dinosam, dinoseb, dinoterb, diphenamid, dipropetryn, diquat, disul, diuron, DMPA, DNOC, DSMA, EBEP, eglinazine, endothal, epronaz, EPTC, erbon, esprocarb, ethbenzamide, ethametsulfuron, ethidimuron, ethiolate, etobenzamid, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenteracol, fenthiaprop, fentrazamide, fenuron, ferrous sulfate, flamprop, flamprop-M, flazasulfuron, florasulam, fluazifop, fluazifop-P-butyl, fluazolate, flucarbazone, flucetosulfuron, fluchloralin, flufenacet, flufenican, flufenpyr-ethyl, flumetsulam, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, fluroxypyr, fluroxypyr-meptyl, flurtamone, fluthiacet, fomesafen, foramsulfuron, fosamine, fumiclorac, furyloxyfen, glufosinate, glufosinate salts and esters, glufosinate-ammonium, glufosinate-P-ammonium, glyphosate, glyphosate salts and esters, halauxifen, halauxifen-methyl, halosafen, halosulfuron-methyl, haloxydine, haloxyfop-methyl, haloxyfop-P-methyl, hexachloroacetone, hexaflurate, hexazinone, imazamethabenz, imazamox, imazapic, imazapyr, imazaquin, imazosulfuron, imazethapyr, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxachlortole, isoxaflutole, isoxapyrifop, karbutilate, ketospiradox, lactofen, lenacil, linuron, MAA, MAMA, ester and amine of MCPA, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, metoprotryne, methyl bromide, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, ortho-dichlorobenzene, orthosulfamuron, oxadiargyl, oxadiazon, oxapyrazon, oxasulfuron, oxaziclomefone, oxyfluorfen, paraflufen-ethyl, parafluron, paraquat, pebulate, pelargonic acid, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, pronamide, propachlor, propanil, propaquizafop, propazine, propisochlor, propoxycarbazone, propyrisulfuron, propyzamide, prosulfalin, prosulfocarb, prosulfuron, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac, pyrimisulfan, pyrithiobac-sodium, pyroxasulfone, pyroxsulam, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, SYN-523, trichloroacetic acid (TCA), tebutam, tebuthiuron, tefuryltrione, tembotrione, tepraloxydim, terbacil, terbucarb, terbuchlor, terbumeton, terbuthylazine, terbutryn, tetrafluoron, thiazafluron, thidiazimin, thidiazuron, thiencarbazone-methyl, thifensulfuron, thifensulfuron-methyl, thiobencarb, tiocarbazil, tioclorim, topramezone, tralkoxydim, triafamone, tri-allate, triasulfuron, triaziflam, tribenuron, tribenuron-methyl, tricamba, triclopyr choline salt, ester and salt of triclopyr, tridiphane, trietazine, trifloxysulfuron, trifluralin, triflusulfuron, trifop, trifopsime, trihydroxytriazine, trimeturon, tripropindan, tritac, tritosulfuron, vernolate, xylachlor, and salt, ester, optically active isomer, and mixture thereof.

The herbicidal composition of the present disclosure may be prepared or diluted during use. The herbicidal composition of the present disclosure may also be a concentrated composition, or a so-called “ready-to-use” composition, i.e., a composition for immediate use. Alternatively, the herbicidal composition of the present disclosure may be applied as a combined spray mixture composed of separate formulations of single active ingredients, for example, a “tank mixing” form.

The herbicidal composition of the present disclosure may be used or prepared in any conventional form, for example: a two-package form, or for example: wettable powder (WP), emulsifiable concentrate (EC), microemulsifiable concentrate (MEC), water-soluble powder (SP), water-soluble concentrate (SL), suspoemulsion (SE), oil dispersions (OD), concentrated emulsion (BW), for example: oil-in-water and water-in-oil emulsions, sprayable solution or emulsion, capsule suspension (CS), suspension concentrations (SC), dried powder (DP), oil miscible solution (OL), seed dressing products, granules in the form of microparticles (GR), spray granules, coated granules and absorbent granules, granules used for applying or spreading in soil, water-soluble granules (SG), water-dispersible granules (WDG), ultra-low volume (ULV) formulations, microcapsules or waxes, these individual formulation types are known in the art.

Such an herbicidal composition may be formulated by using agricultural carrier, surfactant, or other application-promoting auxiliaries conventionally used in formulation techniques and formulation processes known in the art.

In one embodiment of the present disclosure, the total amount of active ingredients in the herbicidal composition may be about 0.1-99 wt. %, about 0.1-95 wt. %, or about 0.1-90 wt. %, based on the total weight of the herbicidal composition. In another embodiment, the total amount of active ingredients in the herbicidal composition accounts for about 20-40 wt. % of the total weight of the composition. In another embodiment, the total amount of active ingredients in the composition accounts for about 0.1%, 0.5%, 1%, 1.5%, 2%, 2.5%, 3%, 3.5%, 4%, 4.5%, 5% to about 90%, 93%, 95%, 98%, 99% of the total weight of the composition.

Aqueous forms for use may be prepared from emulsion concentrate, suspension, paste, wettable powder, or water-dispersible granule by adding water. In order to prepare emulsion, paste or oil dispersion, the components of the herbicidal composition may be taken by themselves or dissolved in an oil or solvent, and it may be homogenized in water by means of wetting agent, tackifier, dispersant or emulsifier. Alternatively, a concentrate may also be prepared, the concentrate comprises: active ingredients, wetting agent, tackifier, dispersant or emulsifier and, if necessary, a solvent or oil suitable for dilution with water.

The herbicidal composition may be applied pre-emergence, post-emergence, or a combination thereof.

In the present disclosure, unless otherwise indicated, all the specific descriptions made in the first aspect apply to the second aspect as all relevant descriptions have been copied here. Similarly, where appropriate, the descriptions regarding the composition in the second aspect may also be applied to the herbicidal mixture in the first aspect, as if all the relevant descriptions are repeated in the corresponding part above. For example, unless otherwise indicated, all the specific descriptions on the herbicidal mixture, pyroxasulfone and the second herbicide, the weight ratio of pyroxasulfone to each second herbicide, the application rate of pyroxasulfone and each second herbicide, the ratio of the application rate of pyroxasulfone to that of each second herbicide, etc., in the first aspect apply to the second aspect as all relevant specific descriptions have been copied here. For another example, unless otherwise indicated, all the specific descriptions on the other active ingredients, e.g., other herbicides in the second aspect apply to the first aspect as all relevant specific descriptions have been copied in corresponding part above.

### Third Aspect

In the third aspect, the present disclosure provides a method for controlling undesirable vegetation, which includes applying a herbicidally effective amount of the herbicidal mixture disclosed in the first aspect or the herbicidal composition disclosed in the second aspect of the present disclosure to the undesirable vegetation or its locus.

In one embodiment of the present disclosure, the undesirable vegetation is controlled in wheat. In one embodiment of the present disclosure, the wheat is winter wheat. In one embodiment of the present disclosure, the wheat is spring wheat.

In one embodiment of the present disclosure, the undesirable vegetation is selected from the group consisting of: Aegilops tauschii, Bromus japonicus, Bromus japonicus, Galium aparine, Lithospermum arvense, Solanum nigrum, and the combination thereof.

In one embodiment of the present disclosure, the herbicidal mixture or the herbicidal composition may be applied pre-emergence.

In one embodiment of the present disclosure, the herbicidal mixture or the herbicidal composition is applied as a soil sealant.

In one embodiment of the present disclosure, the herbicidal mixture or the herbicidal composition may be applied post-emergence.

In one embodiment of the present disclosure, it may be expected to control undesirable vegetation in crops such as corn, peanuts, soybeans, cotton, and the like.

In one embodiment of the present disclosure, the following undesirable vegetation may also be expected to be controlled: Medicago sativa, Amsinckia spp., Arctotheca calendula, Sinapis arvensis, Stellaria media, Buglossoides arvensis, Agropyron repens, Mentha arvensis, Crassula L., Cirsium arvense, Calystegia sepium, Tripleurospermum maritimum, Convolvulus arvensis, Aethusa cynapium, Galinsoga parviflora, Lamium amplexicaule, Sisymbrium officinale, Lythrum hyssopifolia, Sisymbrium orientale, Lolium multiflorum, Malva parviflora, Cerastium glomeratum, Matthiola longipetala, Echium plantagineum, Adonis microcarpa, Matricaria discoidea, Euphorbia pulcherrima, Lactuca serriola, Lamium purpureum, Papaver hybridum, Capsella bursa-pastoris. Chondrilla juncea, Rumex acetosella, Veronica hederifolia, Urtica urens, Juncus bufonius, Rapistrum rugosum, Raphanus raphanistrum, Brassica tournefo rtii, Polygonum aviculare, Mercurialis annua, Datura ferox, Neslia paniculata, Echinochloa crusgalli, sugarbeet, Fallopia convolvulus, Alopecurus myosuroides, Trianthema portulacastrum, Hirschfeldia incana, Tribulus terrestris, Abutilon theophrasti, Hypochaerisradicata, Galium aparine, Anthusa arvensis, Boragio officinales, Cotula australis, Senecio vulgaris, Galeopsis tetrahit, Urtica dioica, Spergula arvensis. Veronica filiformis, Verbesina encelioides, Eleusine indica, Rumex spp., Emex australis, Atriplex prostrata, Sherardia arvensis, Viola arvensis, Thlaspi arvense, Holcus lanatus, Fumaria L., Fumaria officinalis, Geranium spp., Geranium dissectum, Bromus diandrus, Plantago major, Digitaria ciliaris, Conringia orientalis, Heliotropium spp., Galeopsis spp., Marrubium vulgare, Sisymbrium orientale, Coronopusdidy mus, Matricaria spp., Matricaria recutita, Matricaria inodora, Calandrinia ciliata, Brassica juncea, Urtica fissa E. Pritz., Urtica spp., Solanum nigrum, Persicaria lapathifolia, Sonchus arvensis, Veronica persica, Chenopodium spp., Chenopodium album, Amaranthus powellii, Galeopsis intermedia, Persicaria maculosa, Amaranthus retroflexus, Anagallis arvensis, Urtica incisa, Sonchus oleraceus, Emex australis, Atriplex patula, Stachys arvensis, Erodium cicutarium, summer grass, Euphorbia helioscopia, Juncus bufonius, Polygonum convolvulus, Polygonum spp., Viola tricolor, Poa Annua, Avena fatua, Brassica napus, and Amsinckia calycina.

In one embodiment of the present disclosure of the third aspect, the herbicidal mixture or the herbicidal composition of the present disclosure is applied to Aegilops tauschii, Bromus japonicus, Lolium multiflorum Lamk, Galium aparine, Lithospermum arvense, Solanum nigrum, and the combination thereof, the application rate of pyroxasulfone is 11.25-360 g ai/ha, and the application rate of fluorochloridone is 31.25 to 1000 g ai/ha. In one embodiment of the present disclosure of the third aspect, the herbicidal mixture or the herbicidal composition of the present disclosure is applied to Aegilops tauschii, the application rate of pyroxasulfone is 11.25-360 g ai/ha, and the application rate of fluorochloridone is 31.25 to 1000 g ai/ha, more specifically the application rate of pyroxasulfone is 22.5-180 g ai/ha, and the application rate of fluorochloridone is 62.5 to 500 g ai/ha. In one embodiment of the present disclosure of the third aspect, the herbicidal mixture or the herbicidal composition of the present disclosure is applied to Lolium multiflorum Lamk, the application rate of pyroxasulfone is 11.25-360 g ai/ha, and the application rate of fluorochloridone is 31.25 to 1000 g ai/ha, more specifically the application rate of pyroxasulfone is 11.25-45 g ai/ha, and the application rate of fluorochloridone is 31.25 to 125 g ai/ha, more specifically the application rate of pyroxasulfone is 11.25 g ai/ha, and the application rate of fluorochloridone is 31.25 g ai/ha. In one embodiment of the present disclosure of the third aspect, the herbicidal mixture or the herbicidal composition of the present disclosure is applied to Bromus japonicus, the application rate of pyroxasulfone is 11.25-360 g ai/ha, and the application rate of fluorochloridone is 31.25 to 1000 g ai/ha, more specifically the application rate of pyroxasulfone is 11.25-22.5 g ai/ha, and the application rate of fluorochloridone is 31.25 to 62.5 g ai/ha. In one embodiment of the present disclosure of the third aspect, the herbicidal mixture or the herbicidal composition of the present disclosure is applied to Galium aparine, the application rate of pyroxasulfone is 11.25-360 g ai/ha, and the application rate of fluorochloridone is 31.25 to 1000 g ai/ha, more specifically the application rate of pyroxasulfone is 11.25-90 g ai/ha, and the application rate of fluorochloridone is 31.25 to 250 g ai/ha, more specifically the application rate of pyroxasulfone is 11.25-22.5 g ai/ha, and the application rate of fluorochloridone is 31.25 to 62.5 g ai/ha. In one embodiment of the present disclosure of the third aspect, the herbicidal mixture or the herbicidal composition of the present disclosure is applied to Lithospermum arvense, the application rate of pyroxasulfone is 11.25-360 g ai/ha, and the application rate of fluorochloridone is 31.25 to 1000 g ai/ha, more specifically the application rate of pyroxasulfone is 11.25-180 g ai/ha, and the application rate of fluorochloridone is 31.25 to 500 g ai/ha. In one embodiment of the present disclosure of the third aspect, the herbicidal mixture or the herbicidal composition of the present disclosure is applied to Solanum nigrum, the application rate of pyroxasulfone is 11.25-360 g ai/ha, and the application rate of fluorochloridone is 31.25 to 1000 g ai/ha, more specifically the application rate of pyroxasulfone is 11.25-180 g ai/ha, and the application rate of fluorochloridone is 31.25 to 500 g ai/ha, more specifically the application rate of pyroxasulfone is 11.25-45 g ai/ha, and the application rate of fluorochloridone is 31.25 to 125 g ai/ha.

In one embodiment of the present disclosure of the third aspect, the herbicidal mixture or the herbicidal composition of the present disclosure is applied to Aegilops tauschii, Bromus japonicus, Lolium multiflorum Lamk, Galium aparine, Lithospermum arvense, Solanum nigrum, and the combination thereof, the application rate of pyroxasulfone is 11.25-360 g ai/ha, and the application rate of aclonifen is 150 to 4800 g ai/ha. In one embodiment of the present disclosure of the third aspect, the herbicidal mixture or the herbicidal composition of the present disclosure is applied to Aegilops tauschii, the application rate of pyroxasulfone is 11.25-360 g ai/ha, and the application rate of aclonifen is 150 to 4800 g ai/ha, more specifically the application rate of pyroxasulfone is 22.5-180 g ai/ha, and the application rate of aclonifen is 150 to 2400 g ai/ha. In one embodiment of the present disclosure of the third aspect, the herbicidal mixture or the herbicidal composition of the present disclosure is applied to Lolium multiflorum Lamk, the application rate of pyroxasulfone is 11.25-360 g ai/ha, and the application rate of aclonifen is 150 to 4800 g ai/ha, more specifically the application rate of pyroxasulfone is 11.25-45 g ai/ha, and the application rate of aclonifen is 150 to 600 g ai/ha, more specifically the application rate of pyroxasulfone is 11.25 g ai/ha, and the application rate of aclonifen is 150 g ai/ha. In one embodiment of the present disclosure of the third aspect, the herbicidal mixture or the herbicidal composition of the present disclosure is applied to Bromus japonicus, the application rate of pyroxasulfone is 11.25-360 g ai/ha, and the application rate of aclonifen is 150 to 4800 g ai/ha, more specifically the application rate of pyroxasulfone is 11.25-22.5 g ai/ha, and the application rate of aclonifen is 150 to 300 g ai/ha. In one embodiment of the present disclosure of the third aspect, the herbicidal mixture or the herbicidal composition of the present disclosure is applied to Galium aparine, the application rate of pyroxasulfone is 11.25-360 g ai/ha, and the application rate of aclonifen is 150 to 4800 g ai/ha, more specifically the application rate of pyroxasulfone is 11.25-90 g ai/ha, and the application rate of aclonifen is 150 to 1200 g ai/ha, more specifically the application rate of pyroxasulfone is 11.25-45 g ai/ha, and the application rate of aclonifen is 150 to 600 g ai/ha. In one embodiment of the present disclosure of the third aspect, the herbicidal mixture or the herbicidal composition of the present disclosure is applied to Lithospermum arvense, the application rate of pyroxasulfone is 11.25-360 g ai/ha, and the application rate of aclonifen is 150 to 4800 g ai/ha, more specifically the application rate of pyroxasulfone is 11.25-180 g ai/ha, and the application rate of aclonifen is 150 to 2400 g ai/ha. In one embodiment of the present disclosure of the third aspect, the herbicidal mixture or the herbicidal composition of the present disclosure is applied to Solanum nigrum, the application rate of pyroxasulfone is 11.25-360 g ai/ha, and the application rate of aclonifen is 150 to 4800 g ai/ha, more specifically the application rate of pyroxasulfone is 11.25-180 g ai/ha, and the application rate of aclonifen is 150 to 2400 g ai/ha.

In one embodiment of the present disclosure of the third aspect, the herbicidal mixture or the herbicidal composition of the present disclosure is applied to Aegilops tauschii, Bromus japonicus, Lolium multiflorum Lamk, Galium aparine, Lithospermum arvense, Solanum nigrum, and the combination thereof, the application rate of pyroxasulfone is 11.25-360 g ai/ha, and the application rate of diflufenican is 14.0625 to 450 g ai/ha. In one embodiment of the present disclosure of the third aspect, the herbicidal mixture or the herbicidal composition of the present disclosure is applied to Aegilops tauschii, the application rate of pyroxasulfone is 11.25-360 g ai/ha, and the application rate of diflufenican is 14.0625 to 450 g ai/ha. In one embodiment of the present disclosure of the third aspect, the herbicidal mixture or the herbicidal composition of the present disclosure is applied to Lolium multiflorum Lamk, the application rate of pyroxasulfone is 11.25-360 g ai/ha, and the application rate of diflufenican is 14.0625 to 450 g ai/ha, more specifically the application rate of pyroxasulfone is 11.25-60 g ai/ha, and the application rate of diflufenican is 14.0625 to 112.5 g ai/ha, more specifically the application rate of pyroxasulfone is 11.25-22.5 g ai/ha, and the application rate of diflufenican is 14.0625-28.125 g ai/ha. In one embodiment of the present disclosure of the third aspect, the herbicidal mixture or the herbicidal composition of the present disclosure is applied to Bromus japonicus, the application rate of pyroxasulfone is 11.25-360 g ai/ha, and the application rate of diflufenican is 14.0625 to 450 g ai/ha, more specifically the application rate of pyroxasulfone is 11.25-90 g ai/ha, and the application rate of diflufenican is 14.0625 to 112.5 g ai/ha, more specifically the application rate of pyroxasulfone is 11.25-45 g ai/ha, and the application rate of diflufenican is 14.0625 to 56.25 g ai/ha. In one embodiment of the present disclosure of the third aspect, the herbicidal mixture or the herbicidal composition of the present disclosure is applied to Galium aparine, the application rate of pyroxasulfone is 11.25-360 g ai/ha, and the application rate of diflufenican is 14.0625 to 450 g ai/ha, more specifically the application rate of pyroxasulfone is 11.25-180 g ai/ha, and the application rate of diflufenican is 14.0625 to 225 g ai/ha, more specifically the application rate of pyroxasulfone is 11.25-90 g ai/ha, and the application rate of diflufenican is 14.0625 to 112.5 g ai/ha. In one embodiment of the present disclosure of the third aspect, the herbicidal mixture or the herbicidal composition of the present disclosure is applied to Lithospermum arvense, the application rate of pyroxasulfone is 11.25-360 g ai/ha, and the application rate of diflufenican is 14.0625 to 450 g ai/ha, more specifically the application rate of pyroxasulfone is 11.25-180 g ai/ha, and the application rate of diflufenican is 14.0625 to 225 g ai/ha. In one embodiment of the present disclosure of the third aspect, the herbicidal mixture or the herbicidal composition of the present disclosure is applied to Solanum nigrum, the application rate of pyroxasulfone is 11.25-360 g ai/ha, and the application rate of diflufenican is 14.0625 to 450 g ai/ha, more specifically the application rate of pyroxasulfone is 11.25-180 g ai/ha, and the application rate of diflufenican is 14.0625 to 225 g ai/ha.

In one embodiment of the present disclosure of the third aspect, the herbicidal mixture or the herbicidal composition of the present disclosure is applied to Aegilops tauschii, Bromus japonicus, Lolium multiflorum Lamk, Galium aparine, Lithospermum arvense, Solanum nigrum, and the combination thereof, the application rate of pyroxasulfone is 11.25-360 g ai/ha, and the application rate of terbutryn is 140.625 to 4500 g ai/ha. In one embodiment of the present disclosure of the third aspect, the herbicidal mixture or the herbicidal composition of the present disclosure is applied to Aegilops tauschii, the application rate of pyroxasulfone is 11.25-360 g ai/ha, and the application rate of terbutryn is 140.625 to 4500 g ai/ha, more specifically the application rate of pyroxasulfone is 11.25-180 g ai/ha, and the application rate of terbutryn is 140.625 to 2250 g ai/ha. In one embodiment of the present disclosure of the third aspect, the herbicidal mixture or the herbicidal composition of the present disclosure is applied to Lolium multiflorum Lamk, the application rate of pyroxasulfone is 11.25-360 g ai/ha, and the application rate of terbutryn is 140.625 to 4500 g ai/ha, more specifically the application rate of pyroxasulfone is 11.25-22.5 g ai/ha, and the application rate of terbutryn is 140.625 to 281.25 g ai/ha. In one embodiment of the present disclosure of the third aspect, the herbicidal mixture or the herbicidal composition of the present disclosure is applied to Bromus japonicus, the application rate of pyroxasulfone is 11.25-360 g ai/ha, and the application rate of terbutryn is 140.625 to 4500 g ai/ha, more specifically the application rate of pyroxasulfone is 11.25-22.5 g ai/ha, and the application rate of terbutryn is 140.625 to 281.25 g ai/ha. In one embodiment of the present disclosure of the third aspect, the herbicidal mixture or the herbicidal composition of the present disclosure is applied to Galium aparine, the application rate of pyroxasulfone is 11.25-360 g ai/ha, and the application rate of terbutryn is 140.625 to 4500 g ai/ha, more specifically the application rate of pyroxasulfone is 11.25-90 g ai/ha, and the application rate of terbutryn is 140.625 to 1125 g ai/ha. In one embodiment of the present disclosure of the third aspect, the herbicidal mixture or the herbicidal composition of the present disclosure is applied to Lithospermum arvense, the application rate of pyroxasulfone is 11.25-360 g ai/ha, and the application rate of terbutryn is 140.625 to 4500 g ai/ha, more specifically the application rate of pyroxasulfone is 11.25-180 g ai/ha, and the application rate of terbutryn is 140.625 to 2250 g ai/ha. In one embodiment of the present disclosure of the third aspect, the herbicidal mixture or the herbicidal composition of the present disclosure is applied to Solanum nigrum, the application rate of pyroxasulfone is 11.25-360 g ai/ha, and the application rate of terbutryn is 140.625 to 4500 g ai/ha, more specifically the application rate of pyroxasulfone is 11.25-180 g ai/ha, and the application rate of terbutryn is 140.625 to 2250 g ai/ha, more specifically the application rate of pyroxasulfone is 11.25-45 g ai/ha, and the application rate of terbutryn is 140.625 to 562.5 g ai/ha.

The herbicidal mixture or the herbicidal composition of the present disclosure may be applied to undesirable vegetation or its locus by using conventional ground or aerial dusters, sprayers, and pellet applicators, and by other conventional methods known to those skilled in the art.

In one embodiment, the method for controlling undesirable vegetation of the present disclosure achieves a synergistically herbicidal effect. In a further embodiment, the method of controlling undesirable vegetation of the present disclosure achieves a synergistic effect on Aegilops tauschii, Bromus japonicus, Lolium multiflorum Lamk, Galium aparine, Lithospermum arvense, Solanum nigrum, or the combination thereof.

In this disclosure, unless otherwise specified, the above descriptions on herbicidal mixture in the first aspect and herbicidal composition disclosed in the second aspect are applicable to the description regarding the method for controlling undesirable vegetation in the third aspect, as if all the relevant descriptions are repeated herein. Similarly, where appropriate, the descriptions in this section regarding the method for controlling undesirable vegetation in the third aspect may also be applied to the herbicidal mixture in the first aspect and the herbicidal composition in the second aspect, as if all the relevant descriptions are repeated in the corresponding parts above. For example, unless otherwise indicated, all the specific descriptions on the herbicidal mixture, pyroxasulfone and the second herbicide, the weight ratio of pyroxasulfone to the second herbicide, the application rate of pyroxasulfone and the second herbicide, the ratio of the application rate of pyroxasulfone to that of the second herbicide, etc., in the first aspect apply to the third aspect as all relevant specific descriptions have been copied here. For another example, similar to the description of the herbicidal mixture in the first aspect and the herbicidal composition in the second aspect of the present disclosure, in one embodiment of the method for controlling undesirable vegetation of the present disclosure, pyroxasulfone and the second herbicide selected from the group consisting of fluorochloridone, aclonifen, diflufenican and terbutryn are applied in combination or sequentially. In one example, pyroxasulfone and the second herbicide selected from the group consisting of fluorochloridone, aclonifen, diflufenican and terbutryn are separately prepared, and each of them is applied as it is, or diluted to a predetermined concentration for application. In another example, pyroxasulfone and the second herbicide selected from the group consisting of fluorochloridone, aclonifen, diflufenican and terbutryn are separately prepared, and after being diluted to a predetermined concentration if necessary, they are mixed and then applied. In another example, pyroxasulfone and the second herbicide selected from the group consisting of fluorochloridone, aclonifen, diflufenican and terbutryn are formulated together, and then applied as it is, or diluted to a predetermined concentration for application. Similarly, the description on the application rates of pyroxasulfone and the second herbicide selected from the group consisting of fluorochloridone, aclonifen, diflufenican and terbutryn to the specific undesired vegetation in the third aspect may also be applied to the herbicidal mixture in the first aspect and the herbicidal composition in the second aspect, as if all the relevant descriptions are repeated in the corresponding part above.

### Fourth Aspect

In the fourth aspect, the present disclosure provides an use of the herbicidal mixture disclosed in the first aspect or the herbicidal composition disclosed in the second aspect for controlling undesired vegetation.

In one embodiment of the present disclosure, the undesirable vegetation is selected from the group consisting of: Aegilops tauschii, Bromus japonicus, Lolium multiflorum Lamk, Galium aparine, Lithospermum arvense, Solanum nigrum, and the combination thereof.

In this disclosure, unless otherwise specified, the above descriptions on the herbicidal mixture in the first aspect, the herbicidal composition disclosed in the second aspect and the method for controlling undesirable vegetation in the third aspect are applicable to the use in the fourth aspect, as if all the relevant descriptions are repeated herein. For example, unless otherwise indicated, all the specific descriptions on the herbicidal mixture, pyroxasulfone and the second herbicide, the weight ratio of pyroxasulfone to the second herbicide, the application rate of pyroxasulfone and the second herbicide, the ratio of the application rate of pyroxasulfone to that of the second herbicide, etc., in the first aspect apply to the fourth aspect as all relevant specific descriptions have been copied here.

### Fifth Aspect

In the fifth aspect, the present disclosure provides a kit comprising the herbicidal mixture disclosed in the first aspect or the herbicidal composition disclosed in the second aspect of the present disclosure.

In this disclosure, unless otherwise specified, the above descriptions on the herbicidal mixture in the first aspect, the herbicidal composition disclosed in the second aspect and the method for controlling undesirable vegetation in the third aspect are applicable to the use in the fifth aspect, as if all the relevant descriptions are repeated herein. For example, unless otherwise indicated, all the specific descriptions on the herbicidal mixture, pyroxasulfone and the second herbicide, the weight ratio of pyroxasulfone to the second herbicide, the application rate of pyroxasulfone and the second herbicide, the ratio of the application rate of pyroxasulfone to that of the second herbicide, etc., in the first aspect apply to the fifth aspect as all relevant specific descriptions have been copied here.

In addition to the active ingredients (i.e., pyroxasulfone and the second herbicide selected from the group consisting of fluorochloridone, aclonifen, diflufenican and terbutryn) comprised in the herbicidal mixture or the herbicidal described herein, the kit of the present disclosure may also comprise one or more other active ingredients and/or inactive ingredients, the active ingredients and the inactive ingredients may be provided in the herbicidal mixture or provided independently.

In one embodiment of the present disclosure, the kit of the present disclosure comprises pyroxasulfone and the second herbicide selected from the group consisting of fluorochloridone, aclonifen, diflufenican and terbutryn, and they are contained in the same container and optionally combined with a carrier.

In one embodiment of the present disclosure, the kit of the present disclosure comprises the herbicidal mixture of the present disclosure, which is contained in a container.

In one embodiment of the present disclosure, the kit of the present disclosure comprises the herbicidal mixture of the present disclosure, which is optionally combined with a carrier.

In one embodiment of the present disclosure, the kit of the present disclosure comprises the herbicidal composition of the present disclosure, which is contained in a container.

In one embodiment of the present disclosure, the kit of the present disclosure comprises pyroxasulfone and the second herbicide selected from the group consisting of fluorochloridone, aclonifen, diflufenican and terbutryn, and each of them is contained in a separate container and optionally combined with a carrier.

In one embodiment of the present disclosure, the kit of the present disclosure comprises the herbicidal mixture of the present disclosure, and pyroxasulfone and the second herbicide selected from the group consisting of fluorochloridone, aclonifen, diflufenican and terbutryn are each contained in a separate container and optionally combined with a carrier.

In one embodiment of the present disclosure, the kit of the present disclosure comprises the herbicidal composition of the present disclosure, and pyroxasulfone and the second herbicide selected from the group consisting of fluorochloridone, aclonifen, diflufenican and terbutryn and the agricultural carrier are each contained in a separate container.

In one embodiment of the present disclosure, the kit of the present disclosure comprises the herbicidal composition of the present disclosure, and pyroxasulfone and the second herbicide selected from the group consisting of fluorochloridone, aclonifen, diflufenican and terbutryn are each contained in a separate container, and the agricultural carrier is contained in a container containing pyroxasulfone, chlorotoluron, or metsulfuron-methyl.

In one embodiment of the present disclosure, the kit of the present disclosure also comprises instructions on how to apply pyroxasulfone and the second herbicide selected from the group consisting of fluorochloridone, aclonifen, diflufenican and terbutryn, the herbicidal mixture of the present disclosure, or the herbicidal composition of the present disclosure to the undesirable vegetation or its locus.

It should be recognized that, one or more features, aspects, or embodiments of the present disclosure may be combined with one or more other features, aspects, or embodiments of the present disclosure.

It should be recognized that, all embodiments of the present disclosure, including those specifically described for different aspects of the present disclosure, may be combined with any other embodiments of the present disclosure as appropriate.

### Examples

The following examples do not limit the present disclosure, but merely illustrate how the present disclosure is implemented.

Referring to an article of Colby, S. R. i.e., Calculation of the synergistic and antagonistic response of herbicide combinations. Weeds 1967, 15, pp. 20-22 (which is incorporated herein in its entirety by reference), the theoretical value E0 of a given mixture of two active ingredients may be predicted according to the following equation, then evaluating whether there is a synergy.

$$E 0 = X + Y - ( X \times Y \div 100 )$$

in which:

E0 is the theoretical fresh weight survival rate for the mixture of pyroxasulfone and the second herbicide selected from the group consisting of fluorochloridone, aclonifen, diflufenican and terbutryn;

X is the measured fresh weight survival rate for pyroxasulfone used alone at the same dosage as that in the mixture;

Y is the measured fresh weight survival rate for the second herbicide selected from the group consisting of fluorochloridone, aclonifen, diflufenican and terbutryn used alone at the same dosage as that in the mixture;

E is the measured fresh weight survival rate for the mixture of pyroxasulfone and the second herbicide selected from the group consisting of fluorochloridone, aclonifen, diflufenican and terbutryn.

E0-E value is calculated to evaluate the combined effect of pyroxasulfone and the second herbicide selected from the group consisting of fluorochloridone, aclonifen, diflufenican and terbutryn on the selected weeds.

### Example 1: Soil Treatment by a Mixture of Pyroxasulfone and the Second Herbicide Selected from the Group Consisting of Fluorochloridone, Aclonifen, Diflufenican and Terbutryn For Controlling Aegilops tauschii

In this Example, the herbicidal activity of treatments by a mixture of pyroxasulfone and the second herbicide selected from the group consisting of fluorochloridone, aclonifen, diflufenican and terbutryn for controlling Aegilops tauschii was investigated by a pot experiment. This Example was carried out in accordance with “NY/T 1155.4-2006 Guidelines for Indoor Bioassay Tests of Pesticides, Herbicides Part 4: Activity Determination Tests, Stem and Leaf Spray Method”.
Source of the agrochemicals tested were:
Pyroxasulfone: pyroxasulfone (850g/Kg, WG) from Adama Agan LTD.
Fluorochloridone: fluorochloridone (250 g/L, EC) from Adama Agan LTD.
Aclonifen: aclonifen (600 g/L, SC) from Adama Agan LTD.
Diflufenican: diflufenican (50g/Kg, WP) from Bayer.
Terbutryn: terbutryn (50g/Kg, SC) from Zhejiang Zhongshan Chemical Industry Group Co., Ltd.
Cultivation of test materials: The test soil was formed by mixing the 20 cm layer loam on the ground surface and the culture medium in a ratio of 3:1 as cultivation soil. Weeds were cultivated in an artificial climate chamber. The daytime and nighttime temperatures were set at 22° C. and 19° C., respectively, and the illumination was set at daytime: dark time 12h: 12h.

A certain amount of Aegilops tauschii seeds were sown in a plastic pot with a diameter of 9 cm, covering with 1-2 mm soil, and putting them in an enamel dish filled with water. The bottom infiltration method was used to water them, the agrochemicals tested in this Example were applied on the second day after sowing Aegilops tauschii seeds.

Spraying treatment: ASS-4 automatic control spraying system with a fan-shaped nozzle was used indoors to spray the agrochemicals, the running speed was adjusted based on nozzle pressure, flow rate, etc. to spray 50 mL of liquid of agrochemicals on the actual spray area of 1.1 m2 (equivalent to 30 liters per mu), arranging the plastic pots to be processed on the spraying table evenly, and spraying evenly. The spraying pressure was 0.35 MPa, and the flow rate of the fan-shaped nozzle was 800 mL/min, spraying in order from low dosage to high dosage. Each treatment was repeated 3 times. After spraying, the plastic pots were dried for one day, placed in an artificial climate chamber, and watered regularly to keep moist.

Weed investigation method and time: after applying the agrochemicals, the symptoms of weed damage (such as growth inhibition, chlorosis, deformity, etc.) were recorded in detail. After 35 days, the fresh weight of aerial part of the weeds in each treatment was weighed, and the measured fresh weight inhibition rate and the measured fresh weight survival rate for each treatment were calculated according to the following equations:

$$Measure fresh weight inhibition rate ( \% ) = ( weight of the bank control treated fresh weeds - weight of the agent treated fresh weeds ) \div weight of the blank control treated fresh weeds \times 100$$

$$Measured fresh weight survival rate ( \% ) = 100 - measure fresh weight inhibition rate ( \% )$$

The agrochemicals used in this Example, the application rates, and the results were shown in Table 1 below.

TABLE 1

| | | | | Aegilops tauschii | | | |
|---|---|---|---|---|---|---|---|
| | | | | Measured fresh | Measured fresh | Theoretic fresh | |
| | 1^{st} AI | 2^{nd} AI | | weight inhibition | weight survival | weight survival | |
| Agrochemicals | gai/ha) | gai/ha) | Ratio | rate (%) | rate (%) - E | rate (%) - E0 | E0 − E |
| pyroxasulfone | 11.25 | — | — | 4.9 | 95.1 | — | — |
| | 22.5 | — | — | 11.6 | 88.4 | — | — |
| | 45 | — | — | 47.6 | 52.4 | — | — |
| | 90 | — | — | 50.0 | 50.0 | — | — |
| | 180 | — | — | 78.7 | 21.3 | — | — |
| | 360 | — | — | 97.6 | 2.4 | — | — |
| fluorochloridone | 31.25 | — | — | 0.0 | 100.0 | — | — |
| | 62.5 | — | — | 7.9 | 92.1 | — | — |
| | 125 | — | — | 11.0 | 89.0 | — | — |
| | 250 | — | — | 49.4 | 50.6 | — | — |
| | 500 | — | — | 79.3 | 20.7 | — | — |
| | 1000 | — | — | 93.9 | 6.1 | — | — |
| aclonifen | 150 | — | — | 6.1 | 93.9 | — | — |
| | 300 | — | — | 25.0 | 75.0 | — | — |
| | 600 | — | — | 26.2 | 73.8 | — | — |
| | 1200 | — | — | 70.1 | 29.9 | — | — |
| | 2400 | — | — | 74.4 | 25.6 | — | — |
| | 4800 | — | — | 97.6 | 2.4 | — | — |
| diflufenican | 14.0625 | — | — | 3.7 | 96.3 | | |
| | 28.125 | — | — | 6.7 | 93.3 | | |
| | 56.25 | — | — | 4.3 | 95.7 | | |
| | 112.5 | — | — | 6.7 | 93.3 | | |
| | 225 | — | — | 10.4 | 89.6 | | |
| | 450 | — | — | 37.2 | 62.8 | | |
| terbutryn | 140.625 | — | — | 8.5 | 91.5 | | |
| | 281.25 | — | — | 12.8 | 87.2 | | |
| | 562.5 | — | — | 46.3 | 53.7 | | |
| | 1125 | — | — | 97.6 | 2.4 | | |
| | 2250 | — | — | 96.3 | 3.7 | | |
| | 4500 | — | — | 100.0 | 0.0 | | |
| pyroxasulfone + | 11.25 | 31.25 | 0.36:1 | 9.8 | 90.2 | 100.0 | 9.8 |
| fluorochloridone | 22.5 | 62.5 | 0.36:1 | 23.8 | 76.2 | 99.1 | 22.9 |
| | 45 | 125 | 0.36:1 | 54.9 | 45.1 | 94.8 | 49.7 |
| | 90 | 250 | 0.36:1 | 83.5 | 16.5 | 75.3 | 58.8 |
| | 180 | 500 | 0.36:1 | 96.3 | 3.7 | 37.6 | 33.9 |
| | 360 | 1000 | 0.36:1 | 99.4 | 0.6 | 8.4 | 7.8 |
| pyroxasulfone + | 11.25 | 150 | 0.075:1 | 23.2 | 76.8 | 99.7 | 22.9 |
| aclonifen | 22.5 | 300 | 0.075:1 | 37.8 | 62.2 | 97.1 | 34.9 |
| | 45 | 600 | 0.075:1 | 61.6 | 38.4 | 87.5 | 49.1 |
| | 90 | 1200 | 0.075:1 | 86.6 | 13.4 | 65.0 | 51.6 |
| | 180 | 2400 | 0.075:1 | 98.2 | 1.8 | 41.4 | 39.6 |
| | 360 | 4800 | 0.075:1 | 98.8 | 1.2 | 4.7 | 3.5 |
| pyroxasulfone + | 11.25 | 14.0625 | 0.8:1 | 12.2 | 87.8 | 99.8 | 12.0 |
| diflufenican | 22.5 | 28.125 | 0.8:1 | 27.4 | 72.6 | 99.2 | 26.6 |
| | 45 | 56.25 | 0.8:1 | 54.9 | 45.1 | 98.0 | 52.9 |
| | 90 | 112.5 | 0.8:1 | 60.4 | 39.6 | 96.7 | 57.1 |
| | 180 | 225 | 0.8:1 | 86.6 | 13.4 | 91.8 | 78.4 |
| | 360 | 450 | 0.8:1 | 98.2 | 1.8 | 63.7 | 61.9 |
| pyroxasulfone + | 11.25 | 140.625 | 0.08:1 | 17.1 | 82.9 | 99.6 | 16.7 |
| terbutryn | 22.5 | 281.25 | 0.08:1 | 28.7 | 71.3 | 98.5 | 27.2 |
| | 45 | 562.5 | 0.08:1 | 73.2 | 26.8 | 78.0 | 51.2 |
| | 90 | 1125 | 0.08:1 | 98.2 | 1.8 | 51.2 | 49.4 |
| | 180 | 2250 | 0.08:1 | 100.0 | 0.0 | 24.2 | 24.2 |
| | 360 | 4500 | 0.08:1 | 100.0 | 0.0 | 2.4 | 2.4 |

It can be seen from Table 1 that all mixtures of pyroxasulfone and fluorochloridone/aclonifen/diflufenican/terbutryn tested at different application rates achieved a E0-E of at least 2.4 exhibiting a synergistically herbicidal effect. Specifically, the mixture of pyroxasulfone and fluorochloridone achieved a E0-E of 7.8 to 58.8, the mixture of pyroxasulfone and aclonifen achieved a E0-E of 3.5 to 51.6, the mixture of pyroxasulfone and a diflufenican achieved a E0-E of 12 to 78.4, and the mixture of pyroxasulfone and terbutryn achieved a E0-E of 2.4 to 51.2.

### Example 2: Soil Treatment by a Mixture of Pyroxasulfone and the Second Herbicide Selected from the Group Consisting of Fluorochloridone, Aclonifen, Diflufenican and Terbutryn For Controlling Lolium multiflorum Lamk

Example 2 was conducted in substantially the same way as Example 1, except that Lolium multiflorum Lamk was used instead of Aegilops tauschii.

The agrochemicals used in this Example, the application rates, and the results were shown in Table 2 below

TABLE 2

| | | | | Lolium multiflorum Lamk | | | |
|---|---|---|---|---|---|---|---|
| | | | | Measured fresh | Measured fresh | Theoretic fresh | |
| | 1^{st} AI | 2^{nd} AI | | weight inhibition | weight survival | weight survival | |
| Agrochemicals | gai/ha) | gai/ha) | Ratio | rate (%) | rate (%) - E | rate (%) - E0 | E0 − E |
| pyroxasulfone | 11.25 | — | — | 68.2 | 31.8 | — | — |
| | 22.5 | — | — | 94.8 | 5.2 | — | — |
| | 45 | — | — | 100.0 | 0.0 | — | — |
| | 90 | — | — | 100.0 | 0.0 | — | — |
| | 180 | — | — | 100.0 | 0.0 | — | — |
| | 360 | — | — | 100.0 | 0.0 | — | — |
| fluorochloridone | 31.25 | — | — | 93.2 | 6.8 | — | — |
| | 62.5 | — | — | 96.4 | 3.6 | — | — |
| | 125 | — | — | 98.4 | 1.6 | — | — |
| | 250 | — | — | 100.0 | 0.0 | — | — |
| | 500 | — | — | 100.0 | 0.0 | — | — |
| | 1000 | — | — | 100.0 | 0.0 | — | — |
| aclonifen | 150 | — | — | 89.1 | 10.9 | — | — |
| | 300 | — | — | 96.4 | 3.6 | — | — |
| | 600 | — | — | 99.5 | 0.5 | — | — |
| | 1200 | — | — | 100.0 | 0.0 | — | — |
| | 2400 | — | — | 100.0 | 0.0 | — | — |
| | 4800 | — | — | 100.0 | 0.0 | — | — |
| diflufenican | 14.0625 | — | — | 87.0 | 13.0 | — | — |
| | 28.125 | — | — | 88.0 | 12.0 | — | — |
| | 56.25 | — | — | 93.2 | 6.8 | — | — |
| | 112.5 | — | — | 99.5 | 0.5 | — | — |
| | 225 | — | — | 100.0 | 0.0 | — | — |
| | 450 | — | — | 100.0 | 0.0 | — | — |
| terbutryn | 140.625 | — | — | 94.3 | 5.7 | — | — |
| | 281.25 | — | — | 94.8 | 5.2 | — | — |
| | 562.5 | — | — | 100.0 | 0.0 | — | — |
| | 1125 | — | — | 100.0 | 0.0 | — | — |
| | 2250 | — | — | 100.0 | 0.0 | — | — |
| | 4500 | — | — | 100.0 | 0.0 | — | — |
| pyroxasulfone + | 11.25 | 31.25 | 0.36:1 | 96.9 | 3.1 | 36.4 | 33.3 |
| fluorochloridone | 22.5 | 62.5 | 0.36:1 | 99.5 | 0.5 | 8.6 | 8.1 |
| | 45 | 125 | 0.36:1 | 100.0 | 0.0 | 1.6 | 1.6 |
| | 90 | 250 | 0.36:1 | 100.0 | 0.0 | 0.0 | 0.0 |
| | 180 | 500 | 0.36:1 | 100.0 | 0.0 | 0.0 | 0.0 |
| | 360 | 1000 | 0.36:1 | 100.0 | 0.0 | 0.0 | 0.0 |
| pyroxasulfone + | 11.25 | 150 | 0.075:1 | 98.4 | 1.6 | 39.2 | 37.6 |
| aclonifen | 22.5 | 300 | 0.075:1 | 99.5 | 0.5 | 8.6 | 8.1 |
| | 45 | 600 | 0.075:1 | 100.0 | 0.0 | 0.5 | 0.5 |
| | 90 | 1200 | 0.075:1 | 100.0 | 0.0 | 0.0 | 0.0 |
| | 180 | 2400 | 0.075:1 | 100.0 | 0.0 | 0.0 | 0.0 |
| | 360 | 4800 | 0.075:1 | 100.0 | 0.0 | 0.0 | 0.0 |
| pyroxasulfone + | 11.25 | 14.0625 | 0.8:1 | 98.4 | 1.6 | 40.7 | 39.1 |
| diflufenican | 22.5 | 28.125 | 0.8:1 | 99.0 | 1.0 | 16.6 | 15.6 |
| | 45 | 56.25 | 0.8:1 | 100.0 | 0.0 | 6.8 | 6.8 |
| | 90 | 112.5 | 0.8:1 | 100.0 | 0.0 | 0.5 | 0.5 |
| | 180 | 225 | 0.8:1 | 100.0 | 0.0 | 0.0 | 0.0 |
| | 360 | 450 | 0.8:1 | 100.0 | 0.0 | 0.0 | 0.0 |
| pyroxasulfone + | 11.25 | 140.625 | 0.08:1 | 98.4 | 1.6 | 35.7 | 34.1 |
| terbutryn | 22.5 | 281.25 | 0.08:1 | 100.0 | 0.0 | 10.1 | 10.1 |
| | 45 | 562.5 | 0.08:1 | 100.0 | 0.0 | 0.0 | 0.0 |
| | 90 | 1125 | 0.08:1 | 100.0 | 0.0 | 0.0 | 0.0 |
| | 180 | 2250 | 0.08:1 | 100.0 | 0.0 | 0.0 | 0.0 |
| | 360 | 4500 | 0.08:1 | 100.0 | 0.0 | 0.0 | 0.0 |

It can be seen from Table 2 that all mixtures of pyroxasulfone and fluorochloridone/aclonifen/diflufenican/terbutryn tested at lower application rates achieved a E0-E of at least 0.5 exhibiting a synergistically herbicidal effect. Specifically, the mixture of pyroxasulfone and fluorochloridone achieved a E0-E of 1.6 to 33.3, the mixture of pyroxasulfone and aclonifen achieved a E0-E of 0.5 to 37.6, the mixture of pyroxasulfone and a diflufenican achieved a E0-E of 0.5 to 39.1, and the mixture of pyroxasulfone and terbutryn achieved a E0-E of 10.1 to 34.1.

### Example 3: Soil Treatment by a Mixture of Pyroxasulfone and the Second Herbicide Selected from the Group Consisting of Fluorochloridone, Aclonifen, Diflufenican and Terbutryn For Controlling Bromus japonicus

Example 3 was conducted in substantially the same way as Example 1, except that Bromus japonicus was used instead of Aegilops tauschii.

The agrochemicals used in this Example, the application rates, and the results were shown in Table 3 below

TABLE 3

| | | | | Bromus japonicus | | | |
|---|---|---|---|---|---|---|---|
| | | | | Measured fresh | Measured fresh | Theoretic fresh | |
| | 1^{st} AI | 2^{nd} AI | | weight inhibition | weight survival | weight survival rate | |
| Agrochemicals | gai/ha) | gai/ha) | Ratio | rate (%) | rate (%) - E | (%) - E0 | E0 − E |
| pyroxasulfone | 11.25 | — | — | 74.2 | 25.8 | — | — |
| | 22.5 | — | — | 88.7 | 11.3 | — | — |
| | 45 | — | — | 100.0 | 0.0 | — | — |
| | 90 | — | — | 100.0 | 0.0 | — | — |
| | 180 | — | — | 100.0 | 0.0 | — | — |
| | 360 | — | — | — | — | — | — |
| fluorochloridone | 31.25 | — | — | 94.8 | 5.2 | — | — |
| | 62.5 | — | — | 96.9 | 3.1 | — | — |
| | 125 | — | — | 100.0 | 0.0 | — | — |
| | 250 | — | — | 100.0 | 0.0 | — | — |
| | 500 | — | — | 100.0 | 0.0 | — | — |
| | 1000 | — | — | — | — | — | — |
| aclonifen | 150 | — | — | 45.4 | 54.6 | — | — |
| | 300 | — | — | 86.6 | 13.4 | — | — |
| | 600 | — | — | 100.0 | 0.0 | — | — |
| | 1200 | — | — | 100.0 | 0.0 | — | — |
| | 2400 | — | — | 100.0 | 0.0 | — | — |
| | 4800 | — | — | — | — | — | — |
| diflufenican | 14.0625 | — | — | 59.8 | 40.2 | — | — |
| | 28.125 | — | — | 73.2 | 26.8 | — | — |
| | 56.25 | — | — | 80.4 | 19.6 | — | — |
| | 112.5 | — | — | 95.9 | 4.1 | — | — |
| | 225 | — | — | 100.0 | 0.0 | — | — |
| | 450 | — | — | — | — | — | — |
| terbutryn | 140.625 | — | — | 100.0 | 0.0 | — | — |
| | 281.25 | — | — | 100.0 | 0.0 | — | — |
| | 562.5 | — | — | 100.0 | 0.0 | — | — |
| | 1125 | — | — | 100.0 | 0.0 | — | — |
| | 2250 | — | — | 100.0 | 0.0 | — | — |
| | 4500 | — | — | — | — | — | — |
| pyroxasulfone + | 11.25 | 31.25 | 0.36:1 | 99.0 | 1.0 | 29.7 | 28.7 |
| fluorochloridone | 22.5 | 62.5 | 0.36:1 | 100.0 | 0.0 | 14.0 | 14.0 |
| | 45 | 125 | 0.36:1 | 100.0 | 0.0 | 0.0 | 0.0 |
| | 90 | 250 | 0.36:1 | 100.0 | 0.0 | 0.0 | 0.0 |
| | 180 | 500 | 0.36:1 | 100.0 | 0.0 | 0.0 | 0.0 |
| | 360 | 1000 | 0.36:1 | — | — | — | — |
| pyroxasulfone + | 11.25 | 150 | 0.075:1 | 100.0 | 0.0 | 66.3 | 66.3 |
| aclonifen | 22.5 | 300 | 0.075:1 | 100.0 | 0.0 | 23.2 | 23.2 |
| | 45 | 600 | 0.075:1 | 100.0 | 0.0 | 0.0 | 0.0 |
| | 90 | 1200 | 0.075:1 | 100.0 | 0.0 | 0.0 | 0.0 |
| | 180 | 2400 | 0.075:1 | 100.0 | 0.0 | 0.0 | 0.0 |
| | 360 | 4800 | 0.075:1 | — | — | — | — |
| pyroxasulfone + | 11.25 | 14.0625 | 0.8:1 | 99.0 | 1.0 | 55.6 | 54.6 |
| diflufenican | 22.5 | 28.125 | 0.8:1 | 100.0 | 0.0 | 35.1 | 35.1 |
| | 45 | 56.25 | 0.8:1 | 100.0 | 0.0 | 19.6 | 19.6 |
| | 90 | 112.5 | 0.8:1 | 100.0 | 0.0 | 4.1 | 4.1 |
| | 180 | 225 | 0.8:1 | 100.0 | 0.0 | 0.0 | 0.0 |
| | 360 | 450 | 0.8:1 | — | — | — | — |
| pyroxasulfone + | 11.25 | 140.625 | 0.08:1 | 97.9 | 2.1 | 25.8 | 23.7 |
| terbutryn | 22.5 | 281.25 | 0.08:1 | 100.0 | 0.0 | 11.3 | 11.3 |
| | 45 | 562.5 | 0.08:1 | 100.0 | 0.0 | 0.0 | 0.0 |
| | 90 | 1125 | 0.08:1 | 100.0 | 0.0 | 0.0 | 0.0 |
| | 180 | 2250 | 0.08:1 | 100.0 | 0.0 | 0.0 | 0.0 |
| | 360 | 4500 | 0.08:1 | — | — | — | — |

It can be seen from Table 3 that all mixtures of pyroxasulfone and fluorochloridone/aclonifen/diflufenican/terbutryn tested at lower application rates achieved a E0-E of at least 4.1 exhibiting a synergistically herbicidal effect. Specifically, the mixture of pyroxasulfone and fluorochloridone achieved a E0-E of 14.0 to 28.7, the mixture of pyroxasulfone and aclonifen achieved a E0-E of 23.2 to 66.3, the mixture of pyroxasulfone and a diflufenican achieved a E0-E of 4.1 to 54.6, and the mixture of pyroxasulfone and terbutryn achieved a E0-E of 11.3 to 23.7.

### Example 4: Soil Treatment by a Mixture of Pyroxasulfone and the Second Herbicide Selected from the Group Consisting of Fluorochloridone, Aclonifen, Diflufenican and Terbutryn For Controlling Galium aparine

Example 4 was conducted substantially the same way as Example 1, except that Galium aparine was used instead of Aegilops tauschii.

The agrochemicals used in this Example, the application rates, and the results were shown in Table 4 below

TABLE 4

| | | | | Galium aparine | | | |
|---|---|---|---|---|---|---|---|
| | | | | Measured fresh | | | |
| | | | | weight | Measured fresh | Theoretic fresh | |
| | 1^{st} AI | 2^{nd} AI | | inhibition rate | weight survival | weight survival | |
| Agrochemicals | gai/ha) | gai/ha) | Ratio | (%) | rate (%) - E | rate (%) - E0 | E0 − E |
| pyroxasulfone | 11.25 | — | — | 32.9 | 67.1 | — | — |
| | 22.5 | — | — | 78.1 | 21.9 | — | — |
| | 45 | — | — | 95.9 | 4.1 | — | — |
| | 90 | — | — | 95.9 | 4.1 | — | — |
| | 180 | — | — | 100.0 | 0.0 | — | — |
| | 360 | — | — | — | — | — | — |
| fluorochloridone | 31.25 | — | — | 63.0 | 37.0 | — | — |
| | 62.5 | — | — | 84.9 | 15.1 | — | — |
| | 125 | — | — | 93.2 | 6.8 | — | — |
| | 250 | — | — | 95.9 | 4.1 | — | — |
| | 500 | — | — | 100.0 | 0.0 | — | — |
| | 1000 | — | — | — | — | — | — |
| aclonifen | 150 | — | — | 20.5 | 79.5 | — | — |
| | 300 | — | — | 37.0 | 63.0 | — | — |
| | 600 | — | — | 90.4 | 9.6 | — | — |
| | 1200 | — | — | 100.0 | 0.0 | — | — |
| | 2400 | — | — | 100.0 | 0.0 | — | — |
| | 4800 | — | — | — | — | — | — |
| diflufenican | 14.0625 | — | — | 61.6 | 38.4 | — | — |
| | 28.125 | — | — | 72.6 | 27.4 | — | — |
| | 56.25 | — | — | 74.0 | 26.0 | — | — |
| | 112.5 | — | — | 84.9 | 15.1 | — | — |
| | 225 | — | — | 98.6 | 1.4 | — | — |
| | 450 | — | — | — | — | — | — |
| terbutryn | 140.625 | — | — | 19.2 | 80.8 | — | — |
| | 281.25 | — | — | 46.6 | 53.4 | — | — |
| | 562.5 | — | — | 90.4 | 9.6 | — | — |
| | 1125 | — | — | 91.8 | 8.2 | — | — |
| | 2250 | — | — | 100.0 | 0.0 | — | — |
| | 4500 | — | — | — | — | — | — |
| pyroxasulfone + | 11.25 | 31.25 | 0.36:1 | 80.8 | 19.2 | 79.3 | 60.1 |
| fluorochloridone | 22.5 | 62.5 | 0.36:1 | 97.3 | 2.7 | 33.7 | 31.0 |
| | 45 | 125 | 0.36:1 | 98.6 | 1.4 | 10.6 | 9.2 |
| | 90 | 250 | 0.36:1 | 100.0 | 0.0 | 8.0 | 8.0 |
| | 180 | 500 | 0.36:1 | 100.0 | 0.0 | 0.0 | 0.0 |
| | 360 | 1000 | 0.36:1 | — | — | — | — |
| pyroxasulfone + | 11.25 | 150 | 0.075:1 | 91.8 | 8.2 | 93.3 | 85.1 |
| aclonifen | 22.5 | 300 | 0.075:1 | 94.5 | 5.5 | 71.1 | 65.6 |
| | 45 | 600 | 0.075:1 | 100.0 | 0.0 | 13.3 | 13.3 |
| | 90 | 1200 | 0.075:1 | 100.0 | 0.0 | 4.1 | 4.1 |
| | 180 | 2400 | 0.075:1 | 100.0 | 0.0 | 0.0 | 0.0 |
| | 360 | 4800 | 0.075:1 | — | — | — | — |
| pyroxasulfone + | 11.25 | 14.0625 | 0.8:1 | 72.6 | 27.4 | 79.7 | 52.3 |
| diflufenican | 22.5 | 28.125 | 0.8:1 | 97.3 | 2.7 | 43.3 | 40.6 |
| | 45 | 56.25 | 0.8:1 | 100.0 | 0.0 | 29.0 | 29.0 |
| | 90 | 112.5 | 0.8:1 | 100.0 | 0.0 | 18.6 | 18.6 |
| | 180 | 225 | 0.8:1 | 100.0 | 0.0 | 1.4 | 1.4 |
| | 360 | 450 | 0.8:1 | — | — | — | — |
| pyroxasulfone + | 11.25 | 140.625 | 0.08:1 | 89.0 | 11.0 | 93.7 | 82.7 |
| terbutryn | 22.5 | 281.25 | 0.08:1 | 100.0 | 0.0 | 63.6 | 63.6 |
| | 45 | 562.5 | 0.08:1 | 100.0 | 0.0 | 13.3 | 13.3 |
| | 90 | 1125 | 0.08:1 | 100.0 | 0.0 | 12.0 | 12.0 |
| | 180 | 2250 | 0.08:1 | 100.0 | 0.0 | 0.0 | 0.0 |
| | 360 | 4500 | 0.08:1 | — | — | — | — |

It can be seen from Table 4 that all mixtures of pyroxasulfone and fluorochloridone/aclonifen/diflufenican/terbutryn tested at lower application rates achieved a E0-E of at least 1.4 exhibiting a synergistically herbicidal effect. Specifically, the mixture of pyroxasulfone and fluorochloridone achieved a E0-E of 8.0 to 60.1, the mixture of pyroxasulfone and aclonifen achieved a E0-E of 4.1 to 85.1, the mixture of pyroxasulfone and a diflufenican achieved a E0-E of 1.4 to 52.3, and the mixture of pyroxasulfone and terbutryn achieved a E-E of 12.0 to 82.7.

### Example 5: Soil Treatment by a Mixture of Pyroxasulfone and the Second Herbicide Selected from the Group Consisting of Fluorochloridone, Aclonifen, Diflufenican and Terbutryn For Controlling Lithospermum Arvense

Example 5 was conducted substantially the same way as Example 1, except that Lithospermum arvense was used instead of Aegilops tauschii.

The agrochemicals used in this Example, the application rates, and the results were shown in Table 5 below

TABLE 5

| | | | | Lithospermum arvense | | | |
|---|---|---|---|---|---|---|---|
| | | | | Measured fresh | Measured fresh | Theoretic fresh | |
| | 1^{st} AI | 2^{nd} AI | | weight inhibition | weight survival | weight survival rate | |
| Agrochemicals | gai/ha) | gai/ha) | Ratio | rate (%) | rate (%) - E | (%) - E0 | E0 − E |
| pyroxasulfone | 11.25 | — | — | 36.2 | 63.8 | — | — |
| | 22.5 | — | — | 44.9 | 55.1 | — | — |
| | 45 | — | — | 72.5 | 27.5 | — | — |
| | 90 | — | — | 78.3 | 21.7 | — | — |
| | 180 | — | — | 89.9 | 10.1 | — | — |
| | 360 | — | — | — | — | — | — |
| fluorochloridone | 31.25 | — | — | 47.8 | 52.2 | — | — |
| | 62.5 | — | — | 97.1 | 2.9 | — | — |
| | 125 | — | — | 98.6 | 1.4 | — | — |
| | 250 | — | — | 100.0 | 0.0 | — | — |
| | 500 | — | — | 100.0 | 0.0 | — | — |
| | 1000 | — | — | — | — | — | — |
| aclonifen | 150 | — | — | 56.5 | 43.5 | — | — |
| | 300 | — | — | 87.0 | 13.0 | — | — |
| | 600 | — | — | 98.6 | 1.4 | — | — |
| | 1200 | — | — | 100.0 | 0.0 | — | — |
| | 2400 | — | — | 100.0 | 0.0 | — | — |
| | 4800 | — | — | — | — | — | — |
| diflufenican | 14.0625 | — | — | 66.7 | 33.3 | — | — |
| | 28.125 | — | — | 82.6 | 17.4 | — | — |
| | 56.25 | — | — | 84.1 | 15.9 | — | — |
| | 112.5 | — | — | 98.6 | 1.4 | — | — |
| | 225 | — | — | 100.0 | 0.0 | — | — |
| | 450 | — | — | — | — | — | — |
| terbutryn | 140.625 | — | — | 98.6 | 1.4 | — | — |
| | 281.25 | — | — | 98.6 | 1.4 | — | — |
| | 562.5 | — | — | 100.0 | 0.0 | — | — |
| | 1125 | — | — | 100.0 | 0.0 | — | — |
| | 2250 | — | — | 100.0 | 0.0 | — | — |
| | 4500 | — | — | — | — | — | — |
| pyroxasulfone + | 11.25 | 31.25 | 0.36:1 | 91.3 | 8.7 | 82.7 | 74.0 |
| fluorochloridone | 22.5 | 62.5 | 0.36:1 | 98.6 | 1.4 | 56.4 | 55.0 |
| | 45 | 125 | 0.36:1 | 100.0 | 0.0 | 28.5 | 28.5 |
| | 90 | 250 | 0.36:1 | 100.0 | 0.0 | 21.7 | 21.7 |
| | 180 | 500 | 0.36:1 | 100.0 | 0.0 | 10.1 | 10.1 |
| | 360 | 1000 | 0.36:1 | — | — | — | — |
| pyroxasulfone + | 11.25 | 150 | 0.075:1 | 92.8 | 7.2 | 79.5 | 72.3 |
| aclonifen | 22.5 | 300 | 0.075:1 | 100.0 | 0.0 | 60.9 | 60.9 |
| | 45 | 600 | 0.075:1 | 100.0 | 0.0 | 28.5 | 28.5 |
| | 90 | 1200 | 0.075:1 | 100.0 | 0.0 | 21.7 | 21.7 |
| | 180 | 2400 | 0.075:1 | 100.0 | 0.0 | 10.1 | 10.1 |
| | 360 | 4800 | 0.075:1 | — | — | — | — |
| pyroxasulfone + | 11.25 | 14.0625 | 0.8:1 | 78.3 | 21.7 | 75.9 | 54.2 |
| diflufenican | 22.5 | 28.125 | 0.8:1 | 91.3 | 8.7 | 62.9 | 54.2 |
| | 45 | 56.25 | 0.8:1 | 100.0 | 0.0 | 39.0 | 39.0 |
| | 90 | 112.5 | 0.8:1 | 100.0 | 0.0 | 22.8 | 22.8 |
| | 180 | 225 | 0.8:1 | 100.0 | 0.0 | 10. | 10.1 |
| | 360 | 450 | 0.8:1 | — | — | — | — |
| pyroxasulfone + | 11.25 | 140.625 | 0.08:1 | 100.0 | 0.0 | 64.3 | 64.3 |
| terbutryn | 22.5 | 281.25 | 0.08:1 | 100.0 | 0.0 | 55.7 | 55.7 |
| | 45 | 562.5 | 0.08:1 | 100.0 | 0.0 | 27.5 | 27.5 |
| | 90 | 1125 | 0.08:1 | 100.0 | 0.0 | 21.7 | 21.7 |
| | 180 | 2250 | 0.08:1 | 100.0 | 0.0 | 10.1 | 10.1 |
| | 360 | 4500 | 0.08:1 | — | — | — | — |

It can be seen from Table 5 that all mixtures of pyroxasulfone and fluorochloridone/aclonifen/diflufenican/terbutryn tested achieved a E0-E of at least 10.1 exhibiting a synergistically herbicidal effect except for the largest application rates. Specifically, the mixture of pyroxasulfone and fluorochloridone achieved a E0-E of 10.1 to 74.0, the mixture of pyroxasulfone and aclonifen achieved a E0-E of 10.1 to 72.3, the mixture of pyroxasulfone and a diflufenican achieved a E0-E of 10.1 to 54.2, and the mixture of pyroxasulfone and terbutryn achieved a E0-E of 10.1 to 64.3.

### Example 6: Soil Treatment by a Mixture of Pyroxasulfone and the Second Herbicide Selected from the Group Consisting of Fluorochloridone, Aclonifen, Diflufenican and Terbutryn For Controlling Solanum nigrum

Example 6 was substantially conducted in the same as Example 1, except that (1) Solanum nigrum was used instead of Aegilops tauschii, (2) in “Cultivation of test materials” part, Solanum nigrum was cultivated in a glass greenhouse instead of an artificial climate chamber at a temperature of 25 to 33° C. with a natural illumination, and (3) in “Spraying treatment” part, after spraying and drying, the plastic pots were placed in a glass greenhouse instead of an artificial climate chamber.

The agrochemicals used in this Example, the application rates, and the results were shown in Table 6 below

TABLE 6

| | | | | Solanum nigrum | | | |
|---|---|---|---|---|---|---|---|
| | | | | Measured fresh | Measured fresh | Theoretic fresh | |
| | 1^{st} AI | 2^{nd} AI | | weight inhibition | weight survival | weight survival | |
| Agrochemicals | gai/ha) | gai/ha) | Ratio | rate (%) | rate (%) - E | rate (%) - E0 | E0 − E |
| pyroxasulfone | 11.25 | — | — | 17.6 | 82.4 | — | — |
| | 22.5 | — | — | 31.8 | 68.2 | — | — |
| | 45 | — | — | 61.6 | 38.4 | — | — |
| | 90 | — | — | 91.8 | 8.2 | — | — |
| | 180 | — | — | 95.3 | 4.7 | — | — |
| | 360 | — | — | — | — | — | — |
| fluorochloridone | 31.25 | — | — | 18.8 | 81.2 | — | — |
| | 62.5 | — | — | 32.5 | 67.5 | — | — |
| | 125 | — | — | 67.1 | 32.9 | — | — |
| | 250 | — | — | 99.6 | 0.4 | — | — |
| | 500 | — | — | 100.0 | 0.0 | — | — |
| | 1000 | — | — | — | — | — | — |
| aclonifen | 150 | — | — | 12.9 | 87.1 | — | — |
| | 300 | — | — | 17.3 | 82.7 | — | — |
| | 600 | — | — | 30.6 | 69.4 | — | — |
| | 1200 | — | — | 43.1 | 56.9 | — | — |
| | 2400 | — | — | 73.7 | 26.3 | — | — |
| | 4800 | — | — | — | — | — | — |
| diflufenican | 14.0625 | — | — | 5.9 | 94.1 | — | — |
| | 28.125 | — | — | 9.8 | 90.2 | — | — |
| | 56.25 | — | — | 20.8 | 79.2 | — | — |
| | 112.5 | — | — | 28.2 | 71.8 | — | — |
| | 225 | — | — | 36.5 | 63.5 | — | — |
| | 450 | — | — | — | — | — | — |
| terbutryn | 140.625 | — | — | 42.4 | 57.6 | — | — |
| | 281.25 | — | — | 63.9 | 36.1 | — | — |
| | 562.5 | — | — | 99.6 | 0.4 | — | — |
| | 1125 | — | — | 100.0 | 0.0 | — | — |
| | 2250 | — | — | 100.0 | 0.0 | — | — |
| | 4500 | — | — | — | — | — | — |
| pyroxasulfone + | 11.25 | 31.25 | 0.36:1 | 39.2 | 60.8 | 96.7 | 35.9 |
| fluorochloridone | 22.5 | 62.5 | 0.36:1 | 82.7 | 17.3 | 89.7 | 72.4 |
| | 45 | 125 | 0.36:1 | 100.0 | 0.0 | 58.7 | 58.7 |
| | 90 | 250 | 0.36:1 | 100.0 | 0.0 | 8.6 | 8.6 |
| | 180 | 500 | 0.36:1 | 100.0 | 0.0 | 4.7 | 4.7 |
| | 360 | 1000 | 0.36:1 | — | — | — | — |
| pyroxasulfone + | 11.25 | 150 | 0.075:1 | 53.7 | 46.3 | 97.7 | 51.4 |
| aclonifen | 22.5 | 300 | 0.075:1 | 61.6 | 38.4 | 94.5 | 56.1 |
| | 45 | 600 | 0.075:1 | 94.9 | 5.1 | 81.2 | 76.1 |
| | 90 | 1200 | 0.075:1 | 100.0 | 0.0 | 60.4 | 60.4 |
| | 180 | 2400 | 0.075:1 | 100.0 | 0.0 | 29.8 | 29.8 |
| | 360 | 4800 | 0.075:1 | — | — | — | — |
| pyroxasulfone + | 11.25 | 14.0625 | 0.8:1 | 40.8 | 59.2 | 99.0 | 39.8 |
| diflufenican | 22.5 | 28.125 | 0.8:1 | 77.3 | 22.7 | 96.9 | 74.2 |
| | 45 | 56.25 | 0.8:1 | 98.8 | 1.2 | 87.2 | 86.0 |
| | 90 | 112.5 | 0.8:1 | 100.0 | 0.0 | 74.1 | 74.1 |
| | 180 | 225 | 0.8:1 | 100.0 | 0.0 | 65.2 | 65.2 |
| | 360 | 450 | 0.8:1 | — | — | — | — |
| pyroxasulfone + | 11.25 | 140.625 | 0.08:1 | 74.9 | 25.1 | 92.5 | 67.4 |
| terbutryn | 22.5 | 281.25 | 0.08:1 | 100.0 | 0.0 | 79.7 | 79.7 |
| | 45 | 562.5 | 0.08:1 | 100.0 | 0.0 | 38.6 | 38.6 |
| | 90 | 1125 | 0.08:1 | 100.0 | 0.0 | 8.2 | 8.2 |
| | 180 | 2250 | 0.08:1 | 100.0 | 0.0 | 4.7 | 4.7 |
| | 360 | 4500 | 0.08:1 | — | — | — | — |

It can be seen from Table 6 that all mixtures of pyroxasulfone and fluorochloridone/aclonifen/diflufenican/terbutryn tested achieved a E0-E of at least 4.7 exhibiting a synergistically herbicidal effect except for the largest application rates. Specifically, the mixture of pyroxasulfone and fluorochloridone achieved a E0-E of 4.7 to 72.4, the mixture of pyroxasulfone and aclonifen achieved a E0-E of 29.8 to 76.1, the mixture of pyroxasulfone and a diflufenican achieved a E0-E of 39.8 to 86.0, and the mixture of pyroxasulfone and terbutryn achieved a E-E of 4.7 to 79.7.

1. A herbicidal mixture comprising pyroxasulfone and a second herbicide selected from the group consisting of fluorochloridone, aclonifen, diflufenican and terbutryn.

2. The herbicidal mixture of claim 1, wherein the second herbicide is fluorochloridone, and the weight ratio of pyroxasulfone to fluorochloridone is (0.08˜1.6): 1, (0.15˜0.8): 1, or (0.3˜0.4): 1.

3. (canceled)

4. (canceled)

5. The herbicidal mixture of claim 2, wherein the weight ratio of pyroxasulfone to fluorochloridone is about 0.36:1.

6. The herbicidal mixture of claim 1, wherein the second herbicide is aclonifen, and the weight ratio of pyroxasulfone to aclonifen is (0.02˜0.32): 1, (0.03˜0.16): 1, or (0.07˜0.08): 1.

7. (canceled)

8. (canceled)

9. The herbicidal mixture of claim 6, wherein the weight ratio of pyroxasulfone to aclonifen is about 0.075:1.

10. The herbicidal mixture of claim 1, wherein the second herbicide is diflufenican, and the weight ratio of pyroxasulfone to diflufenican is (0.1˜3.6): 1, (0.3˜1.8): 1, or (0.7˜0.9): 1.

11. (canceled)

12. (canceled)

13. The herbicidal mixture of claim 10, wherein the weight ratio of pyroxasulfone to diflufenican is about 0.8:1.

14. The herbicidal mixture of claim 1, wherein the second herbicide is terbutryn, and the weight ratio of pyroxasulfone to terbutryn is (0.01˜0.36): 1, (0.03˜0.18): 1, or (0.07˜0.09): 1.

15. (canceled)

16. (canceled)

17. The herbicidal mixture of claim 14, wherein the weight ratio of pyroxasulfone to terbutryn is about 0.08:1.

18.-23. (canceled)

24. The herbicidal mixture of claim 1, wherein the herbicidal mixture consists of pyroxasulfone and the second herbicide.

25. A herbicidal composition comprising the herbicidal mixture of claim 1, and an agriculturally acceptable carrier.

26. The herbicidal composition of claim 25, further comprising at least one surfactant.

27. A method of controlling undesired vegetation comprising applying to the undesirable vegetation or its locus a herbicidally effective amount of the herbicidal mixture of claim 1.

28. The method of claim 27, wherein the undesired vegetation is controlled in wheat.

29. The method of claim 27, wherein the undesired vegetation is selected from the group consisting of Aegilops tauschii, Bromus japonicus, Lolium multiflorum Lamk, Galium aparine, Lithospermum arvense, Solanum nigrum, and any combination thereof.

30. (canceled)

31. A kit comprising the herbicidal mixture of claim 1.

32. A kit comprising the herbicidal composition of claim 25.

33. A method of controlling undesired vegetation comprising applying to the undesirable vegetation or its locus a herbicidally effective amount of the herbicidal composition of claim 25.

34. The method of claim 33, wherein the undesired vegetation is controlled in wheat.

35. The method of claim 33, wherein the undesired vegetation is selected from the group consisting of Aegilops tauschii, Bromus japonicus, Lolium multiflorum Lamk, Galium aparine, Lithospermum arvense, Solanum nigrum, and any combination thereof.
